(19) United States
(12) Patent Application Publication
(10) Pub. No.: US 2005/0188724 A1
(43) Pub. Date: Sep. 1, 2005

(54) Process for the production of precision press-molding preform and process for the production of optical element

(75) Inventors: Mikio Ikenishi, Tokyo (JP); Xuelu Zou, Tokyo (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 11/063,753

(22) Filed: Feb. 24, 2005

(30) Foreign Application Priority Data
Mar. 1, 2004 (JP) 2004-56436
Mar. 5, 2004 (JP) 2004-62738
Mar. 5, 2004 (JP) 2004-62854
Mar. 5, 2004 (JP) 2004-62879
Sep. 22, 2004 (JP) 2004-275737

(51) Int. Cl. C03B 15/00

(52) U.S. Cl. 65/31; 65/117; 65/102

(57) ABSTRACT

A process for producing a precision press-molding preform having a predetermined weight from a molten glass, wherein the molten glass is shaped into a glass gob and the above glass gob is etched to remove a surface layer of the glass gob to produce the precision press-molding preform formed of an optical glass having said weight, and further wherein said surface layer has a thickness of 0.5 μm or more.

### FIELD OF THE INVENTION

The present invention relates to a process for the production of a precision press-molding preform (a preform for precision press-molding) and a process for the production of an optical element. More specifically, the present invention relates to a process for highly productively producing high-quality precision press-molding preforms by hot-shaping of a glass and a process for highly productively producing high-quality optical elements by precision press-molding of preforms produced by the above process.

### BACKGROUND OF THE INVENTION

Lenses made of an optical glass are in greatly increasing demand as digital cameras, cellular phones, etc., and have become widely used. For complying with the demand, a precision press-molding technique capable of highly productively producing optical elements made of a glass is in the limelight.

The precision press-molding technique is a technique of transferring a highly precisely processed molding surface of a press mold to a glass to form an optical-function surface, and this technique is capable of highly productively mass-producing aspherical lenses, etc., that would require large labor and a high cost when produced, for example, by grinding and polishing. The above precision press-molding technique requires preforms that are smooth on surfaces and free of internal and surface defects.

In the precision press-molding, grinding and polishing of a press-molded product are limited to the minimum processing such as a processing for centering and edging of a lens, or grinding and polishing are not carried out. Further, when preforms have a large excess or deficiency in weight, there may be caused a problem that press-molded products are degraded in accuracy or that a glass is forced out to come into between press mold members during press-molding. The weight accuracy of the preforms is precisely determined for each optical element to be produced.

Meanwhile, as a method for producing a preform, there is known a method in which a molten glass is cast into a die and cooled to prepare a glass block or a glass plate, and the block or plate is cut, ground and polished to obtain a preform having a smooth surface (to be referred to as “cold processing”) or a method in which a molten glass is caused to flow out of a pipe to form a molten glass gob having a weight equivalent to the weight of a preform and a preform is shaped in the process of the glass gob being cooled (to be referred to as “hot shaping”) (for example, see Japanese Patent No. 2746567).

The cold processing has a problem that since a preform is produced through many steps, it requires labor, a time and a cost, and it also has another problem in that it is to be applied to a glass that is easily broken when ground and polished. For accurately bringing the weight of preform into agreement with an intended weight, there are required more labor, a more time period and a larger cost.

As a method of more improving productivity and as a method of producing preforms having high weight accuracy, the spotlight of attention is therefore focused upon the above hot shaping method.

While the above hot shaping method is an excellent method, a molten glass gob equivalent to one preform is separated from a molten glass and the glass gob is directly shaped into a preform, so that it is required to prepare a glass gob that is not only naturally excellent in internal quality but also gives a preform excellent in surface state and weight accuracy.

When the temperature of the glass flowing out of a pipe decreases to excess during hot shaping, the glass comes to be crystallized to undergo devitrification, so that the glass gob can be no longer used for a preform. For preventing the above devitrification, it is required to set the temperature of the glass flowing out of a pipe in a temperature range in which no devitrification takes place and which is sufficiently higher than the liquidus temperature of the glass. When the temperature of the glass flowing out of a pipe is increased for preventing the devitrification, the viscosity of the glass decreases, so that the glass is liable to capture gas foams during shaping, or that an easily volatilizable component (volatile component) volatilizes from the glass surface to cause a slight change in a composition in the vicinity of the surface. Such a change therefore appears as a local change (non-uniformity) in refractive index. This non-uniformity in refractive index is observed as surface striae. Further, since the viscosity decreases, glass is liable to flow back along an outer circumference portion of the flow pipe to wet that portion. A volatile component volatilizes from the glass that has flowed back to alter the glass, and when such a glass is captured in the surface of a glass flowing out of the pipe, the surface layer of a preform is caused to have non-uniformity in refractive index, and surface striae take place.

When an attempt is made to overcome a decrease in yields caused by the devitrification of preforms, after all there is caused a problem that striae, gas foams, etc., occur in a portion in the vicinity of the glass surface to decrease the yield. The actual situation is therefore that it has been difficult to overcome these problems at the same time. The above problems are liable to take place particularly when high-refractivity glasses such as an optical glass containing P₂O₅, Nb₂O₅ and Li₂O, an optical glass containing B₂O₃ and La₂O₃, etc., or fluorine-containing glasses are shaped into preforms.

### DISCLOSURE OF THE INVENTION

Under the circumstances, it is an object of the present invention to provide a process for highly productively producing high-quality precision press-molding preforms by hot shaping of a glass, and a process for highly productively producing high-quality optical elements by precision press-molding of preforms produced by the above process.

For achieving the above object, the present inventor has made diligent studies and found the following. High-quality precision press-molding preforms can be highly productively produced by shaping a molten glass into a glass gob and etching the glass gob to remove a surface layer and by selecting specific conditions therefor or a specific glass, and the object of the present invention can be accordingly achieved. On the basis of the above finding, the present invention has been completed.

That is, according to the present invention, there are provided;
(1) a process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said surface layer has a thickness of 0.5 μm or more (to be referred to as “production process 1-a” hereinafter),
(2) a process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said optical glass has a viscosity of 10 dpa·s or less at a liquidus temperature of the glass (to be referred to as “production process 1-b” hereinafter),
(3) a process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said optical glass is an optical glass having a refractive index (nd) of at least 1.65 and an Abbe's number (vd) of 58 or less (to be referred to as “production process 1-c” hereinafter),
(4) a process for producing a precision press-molding preform having a predetermined weight from a molten glass,
which comprises shaping the molten glass into a glass gob, annealing the glass gob, etching said glass gob to remove a surface layer of the glass gob, and thereby producing the precision press-molding preform formed of an optical glass having said weight (to be referred to as “production process 1-d” hereinafter),
(5) a process for producing a precision press-molding preform having a predetermined weight from a molten glass,
which comprises repeating the step of shaping the molten glass into a glass gob to prepare a plurality of glass gobs having the predetermined weight each, etching said plurality of glass gobs under constant conditions to remove a surface layer of each glass gob, and thereby producing a plurality of precision press-molding preforms each of which is formed of an optical glass having said weight (to be referred to as “production process 1-e” hereinafter),
(6) the process for producing a precision press-molding preform as recited in any one of the above (1) to (5), wherein the entire glass gob is immersed in an etching solution to etch the glass gob,
(7) the process for producing a precision press-molding preform as recited in any one of the above (1) to (6), wherein the molten glass is shaped into a glass gob having a surface constituted of curved surfaces having different curvatures or a spherical glass gob,
(8) a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.65 or more and an Abbe's number (vd) of 35 or less and containing P₂O₅, Nb₂O₅ and Li₂O (to be referred to as “production process 2-a” hereinafter),
(9) a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass comprising, by mol %, 15 to 45% of P₂O₅, 3 to 35% of Nb₂O₅, 2 to 35% of Li₂O, 0 to 20% of TiO₂, O to 40% of WO₃, 0 to 20% of Bi₂O₃, 0 to 30% of B₂O₃, 0 to 25% of BaO, 0 to 25% of ZnO, 0 to 20% of MgO, 0 to 20% of CaO, 0 to 20% of SrO, 0 to 30% of Na₂O, 0 to 30% of K₂O, provided that the total content of Li₂O, Na₂O and K₂O is 45% or less, 0 to 15% of Al₂O₃, 0 to 15% of SiO₂, 0 to 10% of La₂O₃, 0 to 10% of Gd₂O₃, 0 to 10% of Yb₂O₃, 0 to 10% of ZrO₂ and 0 to 10% of Ta₂O₅ (to be referred to as “production process 2-b” hereinafter),
(10) the process for producing a precision press-molding preform as recited in the above (8) or (9), wherein the glass gob is formed of a glass having a viscosity of 10 dPa·s or less at a liquidus temperature of the glass,
(11) the process for producing a precision press-molding preform as recited in the above (8), (9) or (10), wherein the glass gob is immersed in an etching solution to etch the glass gob,
(12) the process for producing a precision press-molding preform as recited in any one of the above (8) to (11), wherein the entire surface of the glass gob is etched to remove a surface layer having a depth of at least 0.5 μm, to produce the precision press-molding preform having a predetermined weight,
(13) the process for producing a precision press-molding preform as recited in any one of the above (8) to (12), wherein the glass gob is annealed and then etched,
(14) a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.75 or more and an Abbe's number (vd) of 25 to 58 and containing B₂O₃ and La₂O₃ (to be referred to as “production process 3-a” hereinafter),
(15) a process for producing a precision press-molding preform from a molten glass, wherein the molten glass is shaped into a glass gob and the entire surface of said glass gob is etched to produce a precision press-molding formed of an optical glass having a predetermined weight, and further wherein said optical glass is an optical glass containing, by mol %, 15 to 60% of B₂O₃, O to 40% of SiO₂, 5 to 22% of La₂O₃, 0 to 20% of Gd₂O₃, 0 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15% of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂, 0 to 10% of Bi₂O₃ and 0 to 1% of Sb₂O₃ (to be referred to as “production process 3-b” hereinafter),
(16) the process for producing a precision press-molding preform as recited in the above (14) or (15), wherein the glass gob has a viscosity of 10 dPa·s or less at a liquidus temperature thereof,
(17) the process for producing a precision press-molding preform as recited in the above (14), (15) or (16), wherein the glass gob is immersed in an etching solution to etch the glass gob,
(18) the process for producing a precision press-molding preform as recited in any one of the above 14 to 17, wherein the entire surface of the glass gob is etched to remove a surface layer having a depth of at least 0.5 μm, to produce a precision press-molding preform having a predetermined weight,
(19) the process for producing a precision press-molding preform as recited in any one of the above (14) to (18), wherein the glass gob is annealed and then etched,
(20) a process for producing a precision press-molding preform formed of an optical glass containing B₂O₃,
which comprises the step of etching the surface of a glass gob formed of said optical glass with an etching solution and then bringing said surface into contact with an organic solvent or the step of etching said glass gob with an etching solution that is a mixture of an acid or an alkali with an alcohol (to be referred to as “production process 3-c” hereinafter),
(21) a process for producing a precision press-molding preform formed of an optical glass containing B₂O₃,
which comprises the step of etching the surface of a glass gob formed of said optical glass with an etching solution and the step of washing the etched glass gob by scrubbing (to be referred to as “production process 3-d” hereinafter),
(22) a process for producing a precision press-molding preform from a molten glass,
which comprises shaping the molten glass that is a fluorine-containing glass into a glass gob, etching said glass gob to remove a surface layer of the glass gob, and thereby producing the precision press-molding preform (to be referred to as “production process 4-a” hereinafter),
(23) the process for producing a precision press-molding preform as recited in the above (22), wherein the glass is a fluorophosphate glass,
(24) the process for producing a precision press-molding preform as recited in the above (23), wherein the fluorophosphate glass contains, by mol %, 0 to 20% of Al(PO₃)₃, 0 to 30% of Ba(PO₃)₂, 0 to 30% of Mg(PO₃)₂, 0 to 30% of Ca(PO₃)₂, 0 to 30% of Sr(PO₃)₂, 0 to 30% of Zn(PO₃)₂, 0 to 15% of NaPO₃, 2 to 45% of AlF₃, 0 to 10% of ZrF₄, 0 to 15% of YF₃, 0 to 15% of YbF₃, 0 to 15% of GdF₃, 0 to 15% of BiF₃, 0 to 10% of LaF₃, 0 to 20% of MgF₂, 2 to 45% of CaF₂, 2 to 45% of SrF₂, 0 to 20% of ZnF₂, 0 to 30% of BaF₂, 0 to 10% of LiF, 0 to 15% of NaF, 0 to 15% of KF, 0 to 5% of Li₂O, 0 to 5% of Na₂O, 0 to 5% of K₂O, 0 to 5% of MgO, 0 to 5% of CaO, 0 to 5% of SrO, 0 to 5% of BaO and 0 to 5% of ZnO,
(25) the process for producing a precision press-molding preform as recited in the above (22), (23) or (24), wherein the glass has an abrasion degree FA of 150 or more,
(26) the process for producing a precision press-molding preform as recited in any one of the above (22) to (25), wherein the glass gob is etched until the surface layer having a depth of 0.5 μm or more from the surface is removed, to produce the preform having a predetermined weight,
(27) the process for producing a precision press-molding preform as recited in any one of the above (22) to (26), wherein the molten glass is shaped into a glass gob having a surface constituted of curved surfaces having different curvatures or a spherical glass gob,
(28) the process for producing a precision press-molding preform as recited in any one of the above (22) to (27), wherein the glass gob is immersed in an etching solution to etch the glass gob,
(29) the process for producing a precision press-molding preform as recited in any one of the above (22) to (28), wherein the step of shaping a glass gob from a molten glass was repeated to produce a plurality of glass gobs having a constant weight each and said plurality of glass gobs were etched under constant conditions to produce a plurality of preforms having a predetermined weight each,
(30) the process for producing a precision press-molding preform as recited in any one of the above (22) to (29), wherein the glass gob is annealed and then etched,
(31) a process for producing an optical element, which comprises the step of precision press-molding the precision press-molding preform produced by the process recited in any one of the above (1) to (30),
(32) the process for producing an optical element as recited in the above (31), wherein the preform is introduced into a press mold, and said press mold and the preform are heated together to carry out the precision press-molding, and
(33) the process for producing an optical element as recited in the above (31), wherein the pre-heated preform is introduced into the press mold to carry out the precision press-molding.

Effect of the Invention

According to the process for producing a precision press-molding preform, provided by the present invention, high-quality precision press-molding preforms can be highly productively produced by hot shaping of a glass.

In particular, defects such as striae, etc., present in a range starting at a glass surface and ending in a deep portion can be removed by hot shaping, so that high-quality preforms can be reliably produced.

Further, it has been difficult to reliably shape high-quality precision press-molding preforms from the following glasses by hot shaping, such as a glass that exhibits a viscosity of 10 dPa·s or less at its liquidus temperature, a glass having a refractive index (nd) of 1.65 or more and an Abbe's number (vd) of 58 or less, which is liable to devitrify during hot shaping or of which the flowing viscosity comes to be lower as its liquidus temperature increases, particularly, a glass having a refractive index (nd) of 1.75 or more and an Abbe's number (vd) of 50 or less, a glass having a refractive index (nd) of 1.75 or more and an Abbe's number (vd) of 25 to 58 and a glass having a refractive index (nd) of 1.65 or more and an Abbe's number (vd) of 35 or less. However, high-quality preforms can be reliably produced from these glasses by hot shaping without applying mechanical processing such as grinding and polishing.

Further, since a defective layer in the vicinity of the surface of a glass whose residual stress is reduced by annealing, the glass is not broken even when the above defective layer is removed until the removal reaches a deep portion.

Further, by combining the feature that a large number of glass gobs having high weight accuracy can be produced by hot shaping with the etching feature that equal amounts of glass are removed under constant etching conditions, there can be also easily produced a large number of high-quality preforms having high weight accuracy.

While it may be thinkable to employ mechanical processing such as grinding and polishing for removing a surface defective layer, such grinding and polishing are limited to cases where the preform has a flat surface or a spherical surface. Besides spherical glass gobs, a glass gob whose surface is constituted of curved surfaces having different curvatures is highly valuable in use. However, it is therefore difficult to remove surface stria layer of such a glass gob. In contrast, according to the present invention, a surface layer can be equivalently removed from a glass gob having such a form by etching, so that preforms having the above form can be highly productively produced. With regard to a spherical glass gob, further, a depth of a surface layer removed by etching is uniform on the entire surface since the glass gob is spherically symmetrical. Spherical preforms can be therefore easily produced by etching.

Further, the above glass gob is immersed in an etching solution to etch the glass gob, so that the entire surface of the glass gob can be relatively easily removed until the removal uniformly reaches a predetermined depth.

The above effects can be effectively produced particularly when high-quality (particularly, high surface-quality) preforms formed of a P₂O₅—Nb₂O₅—Li₂O-containing glass, a B₂O₃—La₂O₃-containing glass and a fluorine-containing glass are produced.

According to the process for producing an optical element, provided by the present invention, there can be highly productively produced high-quality optical elements formed of a high-refractivity glass.

### BRIEF DESCRIPTION OF DRAWINGS

FIG. 1 shows optical microscope photographs of a glass gob taken before and after etching.

FIG. 2 is a schematic cross-sectional view of one example of a precision press-molding apparatus used in Examples.

### PREFERRED EMBODIMENTS OF THE INVENTION

First, the process for producing a precision press-molding preform (to be sometimes simply referred to as “preform” hereinafter), provided by the present invention, will be explained below.

[Process for Producing Preform]

(1) First, the production processes 1-a to 1-e of preforms will be explained.

The process for producing a preform is a process for producing a preform formed of an optically homogeneous optical glass having a predetermined weight by shaping a glass gob from a molten glass and etching said glass gob to remove a surface layer of the glass gob, and it includes the following five embodiments, i.e., the production processes 1-a to 1-e.

The first embodiment of the process (production process 1-a) has a feature in that the thickness of the surface layer to be removed by the etching is 0.5 μm or more.

The second embodiment of the process (production process 1-b) has a feature in that the preform is formed of a glass that exhibits a viscosity of 10 dPa·s or less at its liquidus temperature.

The third embodiment of the process (production process 1-c) has a feature in that the preform is formed of an optical glass having a refractive index (nd) of 1.65 or more and an Abbe's number (vd) of 58 or less.

The fourth embodiment of the process (production process 1-d) is characterized by shaping a glass gob from a molten glass, annealing the glass gob and removing a surface layer of said glass gob by etching to produce a preform formed of an optically homogeneous optical glass.

The fifth embodiment of the process (production process 1-e) is characterized by repeating the step of shaping a glass gob from a molten glass to prepare a plurality of glass gobs having a constant weight each and etching said plurality of glass gobs under constant conditions to remove a surface layer of each glass gob, so that a plurality of preforms formed of an optically homogeneous optical glass each are produced.

The above five embodiments may be combined as required. Those points common to the above five embodiments will be explained below.

For obtaining a glass gob, first, a fully refined and homogenized molten glass is prepared, and the molten glass is caused to flow out of a pipe at a constant flow rate. And, a molten glass gob having a predetermined weight is separated from the molten glass flowing out of the pipe. As a separation method, the molten glass is caused to drop from the pipe, and a glass drop is separated as a glass gob having a predetermined weight (to be referred to as “dropping method” hereinafter). Alternatively, the forward end portion of the molten glass flow flowing out of the pipe is supported with a support, to form a narrow portion between the pipe side of the above glass flow and the forward end portion, and then, the above support is rapidly moved downward to separate a molten glass gob of the forward end portion (to be referred to as “descent-separation method” hereinafter). Alternatively, the molten glass flow flowing out of the pipe is cut with a cutting blade to separate a molten glass gob having a predetermined weight (to be referred to as “mechanical cutting method” hereinafter). The flow rate of the glass from the pipe per unit time period is kept constant, and the separation is made at constant intervals, so that molten glass gobs having equal weights can be obtained.

In the dropping method and the descent-separation method, a cutting mark called a shear mark is not formed unlike the mechanical cutting method. In the present invention, the entire surface of the glass gob formed by hot shaping is removed by etching, so that preforms free of a shear mark can be produced so long as the portion where the shear mark is formed on each of glass gobs obtained by the mechanical cutting method is limited to a portion that is shallower than the depth of a portion to be removed by etching. Since, however, the shear mark sometimes reaches a portion that is deeper than a surface defective layer having striae or gas foams, it is preferred to employ the dropping method or the descent-separation method for separating the molten glass gob.

The dropping method is suitable for forming glass gobs having a weight in the range of 5 to 600 mg to a weight tolerance of ±1% on the basis of a predetermined weight. The descent-separation method is suitable for forming glass gobs having a weight in the range of 200 mg to 100 g to a weight tolerance of ±2% (preferably ±1%) on the basis of a predetermined weight.

In each method, glass gobs having high weight accuracy can be easily prepared as compared with a cold processing method. Making use of the above advantage of the hot shaping method and the advantage of the etching that a constant amount of a surface layer is removed under constant conditions, the production method 1-e makes it possible to easily produce preforms having a predetermined weight from prepared glass gobs having high weight accuracy without impairing the weight accuracy.

In the production process 1-e, preferably, the entire glass gob is immersed in an etching solution. In this method, the concentration and temperature of the etching solution are kept constant, and the time period for the immersion is kept constant, whereby the etching conditions can be easily made constant. In the preferred method above, further, a number of glass gobs are simultaneously immersed in an etching solution, and the glass gobs are simultaneously taken out of the etching solution after a predetermined period of time, whereby the etching conditions can be more easily made constant.

In the production method 1-e, therefore, the weight accuracy of the preforms obtained by the etching can be equivalent to the weight accuracy of the glass gobs.

Then, a separated molten glass gob is received with a glass gob shaping mold, or it is tentatively supported with a molten glass gob support and then discharged to a glass gob shaping mold to shape it into a glass gob. On the glass gob shaping mold, desirably, the glass gob is shaped while it is caused to float by applying air (gas) pressure (to be referred to as “float shaping method” hereinafter).

For example, with a glass gob shaping mold having a concave portion whose bottom is provided with an ejection port for ejecting a gas (called “floating gas”) for applying the above air (gas) pressure, a molten glass gob is supplied to the above concave portion and turned in the concave portion while it is moved upward and downward, whereby a spherical glass gob can be formed. Alternatively, the concave portion is provided with a number of ports for ejecting a gas, or the concave portion is constituted from a porous material, and a floating gas is ejected from the entire internal surface of the concave portion to cause the glass to float, whereby a glass gob can be shaped into a form in conformity with the form of the concave portion.

The glass gob is formed above the glass gob shaping mold, and then it is cooled to its glass transition temperature or a temperature lower than the above temperature before it is taken out of the mold.

When the surface of the thus-obtained glass gob is enlarged and observed through an optical microscope, generally, striae are found on the entire glass gob surface. When the entire surface of the above glass gob is removed by etching until the removal reaches a predetermined depth, the above striae are no longer found on such a glass gob. It is therefore understood that the above striae are surface striae locally present in the vicinity of the glass gob surface. An altered layer of the glass gob surface, such as a burned layer, is only in a portion that starts at the gob surface and ends at a 0.1 μm or less deep portion. However, the surface striae reach a portion having a depth that is visually recognizable through an optical microscope, so that it is desirable to etch the glass gob until the etching reaches at least a portion 0.5 μm or more deep from the glass gob surface.

In the present invention, the portion to be removed by the etching is a glass layer that is called “striae” on a glass surface and has a different refractive index. Of the striae, the surface striae present in the vicinity of the glass surface are generated as follows. When a glass melt is formed, fluorine, boron, etc., having a higher vapor pressure than any other glass component are decreased in amount to cause a difference between the refractive index (nd) that such a portion has and the refractive index that an original glass should have. The surface striae are generally observed in the form of streaks. On the basis of this data, it is understood that an altered glass that causes the striae is distributed in the form of streaks in the vicinity of the surface of the original glass. When the altered glass layer above has a depth of 0.5 μm or less, an image obtained through a lens formed of the above glass is not at all affected due to the diffraction limit of visible light. That is, the altered glass layer that poses a problem is limited to an altered glass layer having a depth of 0.5 μm or more. For completely removing the striae, therefore, the etching amount (depth) is at least required to be 0.5 μm or more. The depth in the etching is preferably 1 μm or more, more preferably 10 μm or more, still more preferably 20 μm or more, particularly preferably 50 m or more. The etching is carried out until the entire glass comes to be so optically homogeneous that no striae are observed and until the etching reaches such a depth that a glass gob having a predetermined weight is obtained. The upper limit of the depth in the etching is not critical. However, it is not necessary to remove an optically homogeneous glass portion, so that the criterion can be a maximum depth of 5 mm. Alternatively, the upper limit of the depth in the etching may be controlled on the basis of the ratio of the weight of a preform/the weight of a glass gob. In this case, the ratio of the weight of a preform/the weight of a glass gob is desirably 80% or more, more desirably 85% or more. As described above, the weight of the glass gob is slightly decreased by the etching, so that it is preferred to shape the glass gob having a predetermined weight plus a weight covering the above weight loss for obtaining a preform having a predetermined weight.

The glass gob that has been etched has a smooth surface and is optically homogeneous, so that the glass gob after the etching can be used as a precision press-molding preform. When a glass gob obtained by hot shaping is etched without annealing, the glass sometimes undergoes cracking due to a residual stress. it is therefore desirable to anneal the glass gob before the etching, in order to decrease or remove the residual stress inside the glass. For the annealing, the glass gob can be maintained at a temperature around a slow cooling point. A phosphate glass has a large thermal expansion coefficient, so that it is liable to have a residual stress when a glass gob is formed therefrom. The above annealing is therefore effective for preventing the cracking during the etching.

While a surface defective layer such as surface striae layer is removed by the etching, it is desirable to decrease the depth of the surface defective layer as small as possible or to decrease the striae for effective utilization of glass and improvement of productivity. For decreasing the depth of the surface defective layer, preferably, a gas is caused to flow along the circumference of a flow pipe and in the flow direction of the glass (vertically downward) in order to prevent the glass from flowing back, or the molten glass is caused to flow out in a dry atmosphere in order to decrease a reaction between ambient water vapors and the glass surface.

The method of causing a gas to flow along the circumference of the pipe is also effective for making smaller the weight of a molten glass drop obtained by the dropping method. In the dropping method, the dropping takes place when the gravity that works on the glass and the surface tension that detains the glass on the forward end of the pipe are no longer balanced to make the gravity greater. When the gas is caused to flow steadily along the circumference of the pipe at a constant rate as described above, the force that is downwardly exerted on the glass is increased, so that a glass drop having a smaller weight than a glass drop obtained without any flowing gas can be caused to drop. Preferably, the gas is caused to flow along the entire circumference of the pipe such that it forms a laminar flow near the forward end of the pipe.

The entire surface of the glass gob is uniformly removed by the etching, so that the preform obtained by the etching has a form analogous to the form of the glass gob. When the glass gob is prepared so as to have a form analogous to the form of an intended preform, therefore, the intended preform having a predetermined form can be also easily obtained.

As optical elements produced by precision press-molding, an overwhelming number of optical elements such as a lens have one axis of rotation symmetry. Desirably, the preform therefore has the form of a sphere or a form having one axis of rotation symmetry (e.g., an ellipsoid of revolution, a form obtained by extending or deforming a sphere in a certain axial direction, or the like.). For producing a preform having the above form, a glass gob having a form analogous to the form of an intended preform can be prepared and etched.

There are glass gobs whose surfaces are constituted of curved surfaces having different curvatures such as glass gobs having one axis of rotation symmetry each, which are glass gobs each of which has the entire surface constituted of curved surfaces and do not include spherical glass gobs. It is difficult to mechanically grind or polish the entire surface of a glass gob having such a form until the polishing reaches a uniform depth. According to the present invention, however, glass gobs having predetermined forms are prepared by hot shaping, and the glass gobs are etched, whereby there can be easily produced preforms that have the above forms and that are formed of optically homogeneous (uniform) glasses.

The above form having one axis of rotation symmetry includes a form having a smooth contour free of any corner or dent in a cross section including the above axis of rotation symmetry, such as a form having the contour of an ellipse in which the minor axis corresponds to the axis of rotation symmetry in the above cross section. Preferably, when one of angles formed by a line connecting any point on the contour of a glass gob (which may be any point on the contour of a preform) in the above cross section to the center of the gravity of the glass gob (which may be the center of the gravity of the preform) on the axis of revolution symmetry and a tangent line contacting the contour on the above point on the contour is taken as θ, and when the above point starts at the axis of revolution symmetry and moves along the contour, the angle θ monotonously increases from 90°, then decreases monotonously and then decreases monotonously to come to be 90° at the other point where the contour crosses the axis of revolution symmetry.

When attention is drawn to the spherical symmetry of a spherical glass gob, the depth of a portion removed by the etching is uniform on the entire surface due to the symmetry, and the merit is that spherical preforms can be easily produced when spherical glass gobs are etched.

The glass to be shaped into a preform will be explained below.

The glass for use in the production processes 1-a, 1-d and 1-e is not specially limited. However, the glass to which the above production processes are commonly applied is preferably a glass for use in the production process 1-b (to be referred to as “glass 1” hereinafter) or a glass for use in the production process 1-c (to be referred to as “glass 2” hereinafter). The glass 1 and the glass 2 will be therefore explained below.

(Glass 1)

The glass 1 is a glass that exhibits a viscosity of 10 dPa·s or less at its liquidus temperature. When a glass gob is shaped (prepared), the flow temperature of a glass (temperature of a molten glass that is caused to flow out) is required to be fully higher than the liquidus temperature of the glass for preventing devitrification. The flow viscosity (viscosity of a molten glass that is caused to flow out) is hence far lower than 10 dPa·s, so that surface defects such as an occurrence of surface striae or fine gas foams captured in the vicinity of the glass surface are liable to occur. Even when glass gobs are prepared from such a glass by hot shaping, a layer having the above surface defects can be removed by the etching, so that high-quality preforms can be reliably produced. The glass to which the present invention can be more effectively applied is a glass that exhibits a viscosity of 6 dPa·s or less at its liquidus temperature, the glass to which the present invention can be still more effectively applied is a glass that exhibits a viscosity of 5 dPa·s or less at its liquidus temperature, and the glass to which the present invention can be yet more effectively applied is a glass that exhibits a viscosity of 4 dPa·s or less at its liquidus temperature. While there is no limitation to be imposed on the lower limit of the viscosity at a liquidus temperature, a viscosity of 1 dpa·s or more can be employed as a criterion.

(Glass 2)

The glass 2 is an optical glass having a refractive index (nd) of 1.65 or more and an Abbe's number (vd) of 58 or less. The glass having the above optical constants, which is imparted with a low-temperature softening property for improving the glass in precision press-moldability, has large contents of high-refractivity-imparting components (such as Nb₂O₅, TiO₂, WO₃, La₂O₃, Gd₂O₃, Y₂O₃, Yb₂O₃, Ta₂O₅, etc.). As compared with conventional stable glasses, therefore, such a glass tends to exhibit a decrease in glass stability in a high-temperature state, and like the glass 1, the viscosity thereof at its liquidus temperature tends to decrease. While such a glass is therefore liable to cause a problem similar to that of the glass 1, according to the present invention, high-quality preforms can be reliably produced even from the glass 2.

Points common to the glass 1 and the glass 2 will be explained below. Typical examples of the glass composition corresponding to the above glass include a glass comprising P₂O₅, Nb₂O₅ and Li₂O (to be referred to as “glass A-1” hereinafter), a glass comprising, by mol %, 15 to 45% of P₂O₅, 3 to 35% of Nb₂O₅, 2 to 35% of Li₂O, 0 to 20% of TiO₂, 0 to 40% of WO₃, 0 to 20% of Bi₂O₃, 0 to 30% of B₂O₃, 0 to 25% of BaO, 0 to 25% of ZnO, 0 to 20% of MgO, 0 to 20% of CaO, 0 to 20% of SrO, 0 to 30% of Na₂O, 0 to 30% of K₂O, provided that the total content of Li₂O, Na₂O and K₂O is 45% or less, 0 to 15% of Al₂O₃, 0 to 15% of SiO₂, 0 to 10% of La₂O₃, 0 to 10% of Gd₂O₃, 0 to 10% of Yb₂O₃, 0 to 10% of ZrO₂ and 0 to 10% of Ta₂O₅ (to be referred to as “glass A-2” hereinafter), a glass comprising B₂O₃ and La₂O₃ (to be referred to as “glass B-1” hereinafter), and a glass comprising, by mol %, 15 to 60% of B₂O₃, 1 to 40% of SiO₂, 5 to 22% of La₂O₃, 0 to 20% of Gd₂O₃, 1 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15% of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂, 0 to 10% of Bi₂O₃ and 0 to 1% of Sb₂O₃ (to be referred to as “glass B-2” hereinafter)

(Glass A-1)

Containing P₂O₅ as a component for forming a glass network structure, Nb₂O₅ as a component for imparting the glass with high-refractivity high-dispersion properties and Li₂O as a component for the low-temperature softening property, the glass containing P₂O₅, Nb₂O₅ and Li₂O materializes the above optical properties and the low-temperature softening property.

In the glass A-1, P₂O₅ is a component for constituting a glass network structure and is an essential component for imparting the glass with stability that permits the production of the glass. However, when the content of P₂O₅ exceeds 45 mol %, the transition temperature and sag temperature of the glass increase, and the glass is liable to be degraded in weather resistance. When the above content is less than 15 mol %, the tendency of the glass toward devitrification is intensified, and the glass is destabilized. The content of P₂O₅ is therefore preferably in the range of 15 to 45 mol %, more preferably in the range of 17 to 40 mol %. Contents of glass components by % to be described hereinafter will represent contents by mol % unless otherwise specified.

Nb₂O₅ is an essential component for imparting the glass with high-refractivity high-dispersion properties as described above. When the content thereof exceeds 35%, the transition temperature and sag temperature of the glass increase, the glass is degraded in stability, the glass has poor high-temperature meltability, and the glass is liable to cause foaming or coloring during precision press-molding. On the other hand, when the above content is less than 3%, the glass is poor in durability, and it is difficult to obtain the predetermined high refractivity. The content of Nb₂O₅ is therefore preferably in the range of 3 to 35%, more preferably in the range of 5 to 30%.

Li₂O is a component effective for decreasing the glass transition temperature as described above, and as compared with other alkali oxide, it neither easily decreases the refractive index, nor degrades the durability of the glass. However, when the content of Li₂O is less than 2%, it is difficult to decrease the glass transition temperature. When it exceeds 35%, the glass is greatly degraded in stability and becomes poor in durability, so that the content of Li₂O is preferably adjusted to the range of 2 to 35%. The content of Li₂O is more preferably in the range of 5 to 30%.

Optional components for the glass A-1 will be explained below.

TiO₂ effectively imparts the glass with high-refractivity high-dispersion properties and improves the glass in stability against devitrification. When the content of TiO₂ exceeds 20%, however, the glass is sharply degraded in stability against devitrification and transmittance, the sag temperature and the liquidus temperature of the glass are also increased, and the glass is liable to be colored during precision press-molding. The content of TiO₂ is therefore preferably 0 to 20%, more preferably 0 to 15%.

WO₃ is a component effective for imparting the glass with high-refractivity high-dispersion properties and the low-temperature softening property. Like alkali metal oxides, WO₃ works to decrease the glass transition temperature and sag temperature and works to increase the refractive index. Further, WO₃ effectively inhibits wettability between the glass and press mold, so that it produces an effect that the releasability of the glass from the mold in precision press-molding is improved. However, when WO₃ is introduced to excess, for example, in an amount of over 40%, the glass is liable to be colored, and the high-temperature viscosity of the glass is decreased, so that it is difficult to carry out hot shaping. The content of WO₃ is therefore preferably 0 to 40%, more preferably in the range of 0 to 35%.

Bi₂O₃ is a component for imparting the glass with high-refractivity high-dispersion properties, it is a component that remarkably expands and stabilizes the region of glass generation, and it is a component for improving the glass in weather resistance. When Bi₂O₃ is introduced, therefore, a glass can be formed even if the content of P₂O₅ is small. Further, when incorporated, Bi₂O₃ can increase the wet angle of the glass when the glass in a molten state is placed on a plate made of platinum. The wet angle is increased as described above, so that the glass does not easily flow back to wet an outer circumference portion of a flow pipe. Further, since the wetting by flowing back is decreased, the glass gob can be improved in weight accuracy. However, when the content of Bi₂O₃ exceeds 20%, the glass is rather liable to be devitrified and at the same time may be liable to be colored, so that the content of Bi₂O₃ is preferably 0 to 20%, more preferably 0 to 15%. For obtaining the above effects produced by the introduction of Bi₂O₃, it is preferred to adjust the content of Bi₂O₃ to 0.2% or more, more preferably 0.5% or more, in the above range.

B₂O₃ is a component effective for improving the glass in meltability and homogenizing the glass, and at the same time, when it is introduced even in a small amount, it changes the bonding property of OH inside the glass and produces an effect that the foaming of the glass is inhibited during precision press-molding. However, when the content of B₂O₃ exceeds 30%, the glass is degraded in weather resistance or the glass is destabilized, so that the content of B₂O₃ is preferably in the range of 0 to 30%, more preferably in the range of 0 to 25%.

BaO is a component that produces effects that the glass is imparted with high refractivity, that the glass is improved in stability against devitrification and that the liquidus temperature is decreased. When WO₃ is introduced, particularly when a large amount of WO₃ is introduced, BaO introduced produces great effects that the coloring of the glass is inhibited and that the glass is improved in stability against devitrification, and when the content of P₂O₅ is small, BaO also has an effect that the glass is improved in weather resistance. However, when the content of BaO exceeds 25%, not only the glass is destabilized, but also the glass transition temperature and sag temperature are increased, so that the content of BaO is preferably 0 to 25%, more preferably 0 to 20%.

ZnO is a component that can be introduced for increasing the refractive index and dispersion of the glass. When introduced in a small amount, ZnO also produces effects that the glass transition temperature, sag temperature and liquidus temperature are decreased. When ZnO is introduced to excess, the glass is greatly degraded in stability against devitrification, and the liquidus temperature may be rather increased. The content of ZnO is therefore preferably 0 to 25%, more preferably in the range of 0 to 20%, still more preferably in the range of 0 to 15%.

MgO, CaO and SrO are components for adjusting the stability and weather resistance of the glass. When they are introduced to excess, the glass is greatly destabilized, so that the content of each is preferably 0 to 20%, more preferably 0 to 15%.

Each of Na₂O and K₂O is a component that can be introduced for improving the glass in devitrification resistance, decreasing the glass transition temperature, sag temperature and liquidus temperature and improving the glass in meltability. However, when the content of either of Na₂O and K₂O is larger than 30%, or when the total content of Li₂O and Na₂O and K₂O is greater than 45%, not only the glass is poor in stability, but also the glass may be poor in weather resistance and durability. Therefore, the content of each of Na₂O and K₂O is preferably 0 to 30%, and the total content of Li₂O and Na₂O and K₂O is 0 to 45%. More preferably, the content of Na₂O is 0 to 20% and the content of K₂O is 0 to 25%, and still more preferably, the content of Na₂O is 0 to 5%. Al₂O₃, SiO₂, La₂O₃, Gd₂O₃, Yb₂O₃, ZrO₂ and Ta₂O₅ are components that can be introduced for adjusting the stability and optical constants of the glass. Since, however, all of these components increase the glass transition temperature, they may degrade the precision press-moldability. Desirably, therefore, the content of each of Al₂O₃ and SiO₂ is limited to 15% or less, and the content of each of La₂O₃, Gd₂O₃, Yb₂O₃, ZrO₂ and Ta₂O₅ is limited to 0 to 10%. More preferably, the content of Al₂O₃ and SiO₂ is 0 to 12%, and the content of each of La₂O₃, Gd₂O₃, Yb₂O₃, ZrO₂ and Ta₂O₅ is 0 to 8%.

Sb₂O₃ is effective as a clarifier for the glass. However, when the content of Sb₂O₃ exceeds 1%, the glass is liable to be foamed during precision press-molding, so that it is preferred to adjust the content thereof to 0 to 1%. Further, other components such as TeO₂ and Cs₂O may be introduced up to a total content of 5% so long as they do not impair the object of the present invention.

However, TeO₂ is toxic, and in view of environmental influences, it is desirable not to use TeO₂. Similarly, it is desirable not to use any one of PbO, As₂O₃, CdO, Tl₂O, radioactive substances and compounds of Cr, Hg, and the like. Further, it is preferred to introduce no Ag₂O, since it is not specially required.

(Glass A-2)

The glass A-2 is an optical glass comprising, by mol %, 15 to 45% of P₂O₅, 3 to 35% of Nb₂O₅, 2 to 35% of Li₂O, 0 to 20% of TiO₂, 1 to 40% of WO₃, 0 to 20% of Bi₂O₃, 0 to 30% of B₂O₃, 0 to 25% of BaO, 0 to 25% of ZnO, 0 to 20% of MgO, 0 to 20% of CaO, 0 to 20% of SrO, 0 to 30% of Na₂O, 0 to 30% of K₂O, provided that the total content of Li₂O, Na₂O and K₂O is 45% or less, 0 to 15% of Al₂O₃, 0 to 15% of SiO₂, 0 to 10% of La₂O₃, 0 to 10% of Gd₂O₃, 0 to 10% of Yb₂O₃, 0 to 10% of ZrO₂ and 0 to 10% of Ta₂O₅. The above compositional ranges are determined for the same reasons as those explained with regard to the glass A-1. The glass A-2 preferably has the same compositional ranges as those of the glass A-1.

The glass A-1 and the glass A-2 are preferably a glass comprising, by mol %, 17 to 40% of P₂O₅, 5 to 30% of Nb₂O₅, 5 to 30% of Li₂O, 0 to 15% of TiO₂, 0 to 35% of WO₃, 0 to 15% of Bi₂O₃, 0 to 25% of B₂O₃, 0 to 20% of BaO, 0 to 15% of ZnO, 0 to 15% of MgO, 0 to 15% of CaO, 0 to 15% of SrO, 0 to 20% of Na₂O, provided that the content of Na₂O is in the range of 0 to 5% by weight, 0 to 25% of K₂O, provided that the total content of Li₂O, Na₂O and K₂O is 0 to 45%, 0 to 12% of Al₂O₃, 0 to 12% of SiO₂, 0 to 8% of La₂O₃, 0 to 8% of Gd₂O₃, 0 to 8% of Yb₂O₃, 0 to 8% of ZrO₂, 0 to 8% of Ta₂O₅ and 0 to 1% of Sb₂O₃. Further, when Bi₂O₃ is introduced for improving the glass in stability and decreasing the wetting of the flow pipe caused by flowing back, the glass A-1 and the glass A-2 are preferably a glass containing 17 to 40% of P₂O, 5 to 30% of Nb₂O₅, 5 to 30% of Li₂O, 0 to 15% of TiO₂, 0 to 35% of WO₃, 0.2 to 15% of Bi₂O₃ (more preferably 0.5 to 15% of Bi₂O₃), 0 to 25% of B₂O₃, 0 to 20% of BaO, 0 to 15% of ZnO, 0 to 15% of MgO, 0 to 15% of CaO, 0 to 15% of SrO, 0 to 20% of Na₂O, provided that the content of Na₂O is in the range of 0 to 5% by weight, 0 to 25% of K₂O, provided that the total content of Li₂O, Na₂O and K₂O is 0 to 45%, 0 to 12% of Al₂O₃, 0 to 12% of SiO₂, 0 to 8% of La₂O₃, 0 to 8% of Gd₂O₃, to 8% of Yb₂O₃, 0 to 8% of ZrO₂, 0 to 8% of Ta₂O₅ and 0 to 1% of Sb₂O₃.

Suitably, the glass A-1 and the glass A-2 have a refractive index (nd) of 1.65 or more and an Abbe's number (vd) of 35 or less, and the refractive index (nd) is more preferably 1.75 or more, still more preferably 1.80 or more. While the upper limit of the refractive index (nd) is not specially limited, a refractive index (nd) of 2.1 or less can be employed as a criterion. On the other hand, the Abbe's number (vd) of each of the glass I and the glass II is preferably 30 or less, more preferably 25 or less. While the lower limit of the Abbe's number (vd) is not specially limited, an Abbe's number (vd) of 15 or less can be employed as a criterion.

For an improvement in precision press-moldability, the glass A-1 and the glass A-2 preferably have a glass transition temperature (Tg) of 550° C. or lower, and they preferably have a sag temperature (Ts) of 600° C. or lower. It is preferred to carry out precision press-molding at a temperature that is 30 to 60° C. higher than the sag temperature of the glass used. Due to the above low-temperature softening property, the precision press-molding can be therefore carried out at a low temperature of 700° C. or lower. When the sag temperature exceeds 650° C., and when the pressing temperature accordingly comes to be 700° C. or higher, OH adhering to the surface of a preform sometimes reacts with a press mold to be decomposed, and a number of foams are sometimes left on the surface of a precision press-molded product. Such foams not only degrade the surface accuracy of an optical element produced, but also they damage the molding surface of a press mold. When the glass imparted with the above low-temperature softening property is used, the above problem can be overcome.

When preforms are produced, by hot shaping, from the above glass A containing, as an essential component, Li₂O that is a low-viscosity and volatile component and containing B₂O₃ as an optional component, the present invention enables the production of high-quality preforms.

As raw materials for the glass A-1 and the glass A-2, H₃PO₄, a metaphosphate, diphosphorus pentoxide, etc., can be used for P₂O₅, H₃BO₃, B₂O₃, etc., can be used for B₂O₃, and carbonates, nitrates, oxides, etc., can be used for the other components as required. Predetermined amounts of these materials are weighed and mixed to prepare a raw material mixture, the raw material mixture is poured into a melting furnace having a temperature of 1,000 to 1,400° C., melted, refined and stirred to obtain a homogeneous molten glass, and the thus-obtained molten glass can be used.

(Glass B-1)

In the B₂O₃—La₂O₃-containing glass, B₂O₃ is an essential component for forming a glass network structure. Particularly, when La₂O₃ is introduced, and further, when a large amount of a high-refractivity component such as Gd₂O₃ is introduced, B₂O₃ is required as a main component for forming a glass network structure for forming a glass. However, when the content of B₂O₃ exceeds 60%, the refractive index of the glass is decreased, which is not suited for an object to obtain a high-refractivity glass. On the other hand, when the above content is less than 15%, no sufficient stability against devitrification can be obtained, and the glass is degraded in meltability, so that the content of B₂O₃ is preferably 15 to 60%. The content of B₂O₃ is more preferably 20 to 60%, still more preferably in the range of 20 to 45%.

While SiO₂ is an optional component, it works like B₂O₃ as a component for forming a glass network structure. When a small amount of SiO₂ as a replacement for part of the content of B₂O₃ as a main component is introduced into a glass having a large content of La₂O₃ or Gd₂O₃, the liquidus temperature of the glass is decreased, the high-temperature viscosity is increased, and, further, the glass is greatly improved in stability. However, when the content of SiO₂ exceeds 40%, not only the refractive index of the glass is decreased, but also the glass transition temperature is increased, so that precision press-molding is difficult. The content of SiO₂ is therefore preferably adjusted to 0 to 40%. The content of SiO₂ is more preferably 0 to 30%, still more preferably in the range of 0 to 10%.

La₂O₃ is an essential component for increasing the refractive index (nd) and improving the chemical durability of the glass without decreasing the stability of the glass against devitrification or increasing the dispersion of the glass. However, when the content of La₂O₃ is less than 5%, no sufficient effects are produced, and when it exceeds 22%, the glass is greatly degraded in stability against devitrification. The content of La₂O₃ is therefore preferably adjusted to the range of 5 to 22%. The content of La₂O₃ is more preferably 5 to 20%, still more preferably in the range of 7 to 18%.

Like La₂O₃, Gd₂O₃ works to increase the refractive index (nd), and works to improve the glass in chemical durability, without increasing the stability of the glass against devitrification or increasing dispersion. Particularly, when La₂O₃ and Gd₂O₃ are caused to be co-present, the glass can be more improved in stability. Therefore, the glass B preferably contains Gd₂O₃. However, when the content of Gd₂O₃ exceeds 20%, the glass is degraded in stability against devitrification, and the glass transition temperature is increased, so that the glass is degraded in precision press-moldability. The content of Gd₂O₃ is therefore preferably adjusted to 0 to 20%. The content of Gd₂O₃ is more preferably 1 to 18%, still more preferably in the range of 2 to 16%.

ZnO is a component for decreasing the melting temperature and liquidus temperature of the glass and decreasing the glass transition temperature and is also a component effective for adjusting the refractive index. For producing the above effects expected, it is preferred to introduce 2% or more of ZnO. However, when the content of ZnO exceeds 45%, the dispersion of the glass is increased, and the glass is degraded in stability against devitrification and is also degraded in chemical durability. Therefore, the content of ZnO is preferably in the range of 0 to 45%, more preferably in the range of 1 to 45%, still more preferably in the range of 1 to 32%, yet more preferably in the range of 1 to 20%.

Li₂O is a component that remarkably decreases the glass transition temperature without involving any great decrease in refractive index or a decrease in chemical durability, as compared with any other alkali metal oxide component. Particularly, large effects are produced even when it is introduced in a small amount, and it is a component effective for adjusting thermal properties of the glass (glass transition temperature, sag temperature, and the like). However, when the content of Li₂O exceeds 15%, the glass is sharply degraded in stability against devitrification, and the liquidus temperature of the glass is also increased, so that the content of Li₂O is preferably adjusted to 0 to 15%. The content of Li₂O is more preferably in the range of 0.5 to 15%, still more preferably in the range of 1 to 12%, yet more preferably in the range of 2 to 12%.

Na₂O and K₂O are components that are introduced for decreasing the glass transition temperature. Since, however, each of these components decreases the refractive index of the glass, it is preferred to adjust the content of each to 0 to 10%. The content of each of Na₂O and K₂O is more preferably 0 to 8%.

ZrO₂ is used as a component for attaining high-refractivity low-dispersion properties. When a small amount of ZrO₂ is introduced, the ZrO₂ produces an effect that the glass is improved in the high-temperature viscosity of the glass and stability thereof against devitrification without a decrease in refractive index. However, when the content of ZrO₂ exceeds 15%, the liquidus temperature is sharply increased, and the glass is also degraded in stability against devitrification, so that it is preferred to adjust the content of ZrO₂ to 0 to 15%. The content of ZrO₂ is more preferably in the range of 0 to 10%, still more preferably in the range of 1 to 10%.

Ta₂O₅ is used as a component for imparting the glass with high-refractivity low-dispersion properties. When a small amount of Ta₂O₅ is introduced, the Ta₂O₅ produces an effect that the glass is improved in high-temperature viscosity and stability against devitrification without a decrease in refractive index. However, when the content of Ta₂O₅ exceeds 15%, the liquidus temperature is sharply increased, and the dispersion is increased, so that it is preferred to adjust the content of Ta₂O₅ to 0 to 15%. The content of Ta₂O₅ is more preferably in the range of 0 to 10%, still more preferably in the range of 1 to 8%.

WO₃ is a component that is introduced as required for improving the glass in stability and meltability and improving the glass in refractivity. However, when the content of WO₃ exceeds 15%, the dispersion is increased, and necessary low dispersion property can be no longer obtained. It is therefore preferred to adjust the content of WO₃ to 0 to 15%. The content of WO₃ is more preferably over 0% but not more than 15%, still more preferably in the range of 1 to 15%, yet more preferably in the range of 1 to 12%.

Nb₂O₅ is a component that is introduced as required for improving the glass in stability and refractivity. However, when the content of Nb₂O₅ exceeds 10%, the dispersion is increased, and necessary low-dispersion property can be no longer obtained. It is therefore preferred to adjust the content of Nb₂O₅ to 0 to 10%. The content of Nb₂O₅ is more preferably 0 to 8%, still more preferably in the range of 0 to 5%.

MgO, CaO and SrO are components that are introduced for decreasing the liquidus temperature and transition temperature of the glass, and these components remarkably produce the above effects particularly on a glass containing Nb₂O₅. However, these components may degrade the glass in stability and optical properties, so that it is preferred to adjust the content of each of these components to 0 to 15%. The content of each of these components is more preferably in the range of 0 to 12%, still more preferably in the range of 0 to 10%.

BaO is used as a component for imparting the glass with high-refractivity low-dispersion properties, and when it is introduced in a small amount, it increases the stability of the glass and improves the glass in chemical durability. However, when the content of BaO exceeds 15%, it greatly impairs the stability of the glass against devitrification and increases the transition temperature and sag temperature of the glass, so that it is preferred to adjust the content of BaO to 0 to 15%. The content of BaO is more preferably in the range of 0 to 10%.

Y₂O₃ and Yb₂O₃ are also used as components for imparting the glass with high-refractivity low-dispersion properties, and when it is introduced in a small amount, it increases the stability of the glass and improves the glass in chemical durability. However, when the content of each of Y₂O₃ and Yb₂O₃ exceeds 15%, each of these components greatly impairs the stability of the glass against devitrification and increases the transition temperature and sag temperature of the glass, so that it is preferred to adjust the content of each of these components to 0 to 15%. The content of each of Y₂O₃ and Yb₂O₃ is more preferably in the range of 0 to 10%. When being co-present with La₂O₃, each of Y₂O₃ and Yb₂O₃ is further promoted to improve the glass in stability.

TiO₂ is a component for increasing the refractivity of the glass as well. However, when it is introduced to excess, the glass is degraded in stability and is colored, so that it is preferred to adjust the content of TiO₂ to 0 to 20%.

Bi₂O₃ works to increase the refractive index and works to improve the glass in stability. However, when it is introduced to excess, the glass is colored, so that it is preferred to adjust the content of Bi₂O₃ to 0 to 10%.

Sb₂O₃ is used as a defoaming agent. It is sufficient to use 1% or less of Sb₂O₃ for obtaining a full effect. Further, when the content of Sb₂O₃ is increased, the molding surface of a press mold may be damaged during precision press-molding. It is therefore preferred to adjust the content of Sb₂O₃ in the range of 0 to 1%.

For attaining the high functionalities of high-refractivity and low-dispersion (nd>1.75 and vd>25) in the glass comprising B₂O₃, SiO₂, La₂O₃, Gd₂O₃, ZnO, Li₂O, ZrO₂ and Ta₂O₅ as components, it is preferred to adjust the total content of La₂O₃ and Gd₂O₃ to 12% or more, and it is more preferred to adjust the above total content to 12 to 35%.

Further, the ratio of La₂O₃/Ln₂O₃, which is a ratio (fraction) of the content of La₂O₃ by mol % to the total content of lanthanoid oxides, Ln₂O₃ (Ln=La, Gd, YB, Y, Sc), in the glass by mol %, is preferably adjusted to the range of from 0.3 to 1, and it is more preferably adjusted to the range of from 0.4 to 0.9. The reason therefor is as follows.

For obtaining a glass for precision press-molding, it is required to add Li₂O, etc., which impart the glass with the suitable to precision press-molding, i.e., a low glass transition temperature but which are components that destabilize the glass. When the content of lanthanoid oxides indispensable for the high-refractivity low-dispersion properties is increased, it is difficult to form any glass. However, the proportion (the above fraction) of La₂O₃ to the lanthanoid oxides is adjusted to from 0.3 to 1, whereby a stable glass can be obtained while the content of the lanthanoid oxides is increased, and it comes to be possible to stably form a glass with regard to the glass containing Li₂O, etc., which decrease the glass stability. Further, maintaining the above ratio contributes greatly to a decrease in the liquidus temperature and an improvement in the high-temperature viscosity. When La₂O₃/ΣLn₂O₃ is adjusted to the above range, there can be obtained a glass that is by far stabler than any glass of which the above ratio is greater even if the total content of Ln₂O₃ is the same. For the above reason, further, it is more preferred to adjust the total content of La₂O₃, Gd₂O₃, Yb₂O₃, Y₂O₃ and Sc₂O₃ (ΣLn₂O₃) to 12 to 35%.

The glass B-1 may contain GeO₂. GeO₂ is a component that stabilizes the glass like SiO₂ and imparts the glass with a higher refractive index than SiO₂. For attaining a high refractive index, GeO₂ may be introduced as required. However, GeO₂ is expensive and increases the dispersion, so that it is preferred to limit the content of GeO₂ to 0 to 8%. The content of GeO₂ is preferably 0 to 1%, and it is more preferred to introduce no GeO₂.

PbO is a component that is easily reduced, so that it is precipitated due to its reduction during precision press-molding and causes the surface of a molded product to be cloudy. Further, PbO is an environmentally undesirable substance, so that it is desirable to preclude PbO from the glass.

Lu₂O₃ is not so frequently used as any other component. It also has a high scarcity value and is hence expensive as a raw material for an optical glass, so that it is undesirable to use Lu₂O₃ in view of a cost. Further, there is no positive need to introduce the same. It is hence desirable to introduce no Lu₂O₃.

It is also desirable to preclude elements that cause environmental problems such as cadmium, chromium, mercury, etc., radioactive elements such as thorium, etc., and toxic elements such as arsenic, and the like.

In addition, the glass B may contain TiO₂, Al₂O₃, Ga₂O₃, etc., for adjusting the properties of the glass B so long as the total content thereof is 5% or less.

Some examples of the glass B-1 preferably include the following embodiments.

A glass having a co-presence of B₂O₃, La₂O₃ and Gd₂O₃, a glass having a co-presence of B₂O₃, La₂O₃ and ZnO, a glass having a co-presence of B₂O₃, La₂O₃, Gd₂O₃ and ZnO, a glass having a co-presence of B₂O₃, La₂O₃, Gd₂O₃, ZnO and Li₂O, a glass having a co-presence of B₂O₃, SiO₂, La₂O₃, Gd₂O₃, ZnO, Li₂O, ZrO₂ and Ta₂O₅.

A glass comprising, as glass components, 15 to 60% of B₂O₃, 0 to 40% of SiO₂, 5 to 22% of La₂O₃, 0 to 20% of Gd₂O₃, 0 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15% of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂ and 0 to 10% of Bi₂O₃.

Further, a glass that is one of the above glasses and has a B₂O₃, SiO₂, ZnO, Li₂O, La₂O₃, Gd₂O₃, ZrO₂, Ta₂O₅, WO₃, Y₂O₃ and Yb₂O₃ total content of 95% or more is more preferred. A glass that is one of the above glasses and of which the above total content is 99% or more is still more preferred. A glass that is one of the above glasses and of which the above total content is 100% or more is yet more preferred

(Glass B-2)

The glass B-2 is an optical glass comprising, by mol %, 15 to 60% of B₂O₃, 0 to 40% of SiO₂, 5 to 22% of La₂O₃, 0 to 20% of Gd₂O₃, 0 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15% of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂, 0 to 10% of Bi₂O₃ and 0 to 1% of Sb₂O₃. The glass B-2 preferably has the same compositional ranges as those of the glass B-1.

The glass B-1 and the glass B-2 are more preferably a glass comprising 20 to 45% of B₂O₃, 1 to 30% of SiO₂, 7 to 18% of La₂O₃, 2 to 16% of Gd₂O₃, 5 to 32% of ZnO, 2 to 12% of Li₂O, 0 to 8% of Na₂O, 0 to 8% of K₂₀, 1 to 10% of ZrO₂, 1 to 8% of Ta₂O₅, 0 to 12% of WO₃, 0 to 5% of Nb₂O₅, 0 to 12% of MgO, 0 to 12% of CaO, 0 to 12% of SrO, 0 to 10% of BaO, 0 to 10% of Y₂O₃, 0 to 10% of Yb₂O₃ and 0 to 1% of Sb₂O₃, having an La₂O₃ and Gd₂O₃ total content of 12 to 35% and having an La₂O₃/Ln₂O₃ ratio of from 0.3 to 1.

The glass B-1 and the glass B-2 are preferably a glass having a refractive index (nd) of 1.75 or more and an Abbe's number (vd) of 25 to 58, and are particularly preferably a glass that characteristically satisfies an Abbe's number (vd) in the range of 30 to 50. Desirably, the glass B-1 and the glass B-2 materialize characteristic features that the Abbe's number (vd) is 30 to 40 and that the refractive index (nd) is over 1.84 (to be referred to as “first range” hereinafter) and also materialize characteristic features that the Abbe's number (vd) is 40 to 50 and that the refractive index (nd) is in the range represented by the following expression (1) (to be referred to as “second range” hereinafter).
nd>2.16−0.008×vd (1)

The first range is a range in which the refractive index (nd) is remarkably high and the liquidus viscosity is lower among those of the glass 2. When the refractive index (nd) is constant, the smaller the Abbe's number (vd) is, the relatively more easily a high-refractivity glass can be improved in stability. However, as the Abbe's number (vd) increases, it is more difficult to obtain a stable glass. Like the first range, therefore, the liquidus viscosity in the second range is lower among those of the glass B. While the upper limit of the refractive index is not specially limited, a refractive index of 2.1 or less can be employed as a criterion.

For improving the glass in precision press-moldability, the glass B-1 and the glass B-2 preferably have a glass transition temperature (Tg) of 600° C. or lower, and preferably have a sag temperature (Ts) of 650° C. or lower. The precision press-molding is preferably carried out at a temperature that is 30 to 60° C. higher than the sag temperature of the glass used. Due to the above low-temperature softening properties, therefore, the precision press-molding can be carried out at a temperature of about 700° C. or a temperature of 700° C. or lower. When the sag temperature exceeds 650° C., and the pressing temperature comes to be higher than 700° C., OH adhering to the surface of a preform sometimes reacts with a press mold to be decomposed, and a number of foams are left on the surface of a precision press-molded product. Such forms not only decrease the surface accuracy of an optical element formed, but also they damage the molding surface of a press mold. When the glass imparted with the above low-temperature softening property is used, the above problems can be overcome.

As described above, according to the present invention, high-quality preforms can be produced even when the preforms are prepared, by hot shaping, from a glass containing B₂O₃ and Li₂O that are volatile components.

The glass B-1 and the glass B-2 can be produced, for example, by a conventional method in which raw material compounds are mixed followed by melting, refining, stirring and homogenization. Each of the glass B-1 and the glass B-2 in a molten state is separately cast into a 40×70×15 mm carbon-made mold (die) and gradually cooled to the glass transition temperature thereof and then the glass is annealed at the glass transition temperature for 1 hour and then allowed to cool to room temperature. In this case, no crystal observable through a microscope is precipitated. The glass B-1 and the glass B-2 are thus excellent in stability.

In the production processes 1-a to 1-e of the present invention, further, there can be also used a glass containing fluorine that easily volatilizes during hot shaping. Examples of such a fluorine-containing glass include a fluorophosphate glass, a fluorine-containing silicate glass, a fluorine-containing borosilicate glass, a fluorine-containing borate glass, and the like. Of these, a fluorophosphate glass is a key glass as a raw material for preforms formed of a low-dispersion glass having an Abbe's number (vd) of 65 or more. Further, it is imparted with near infrared absorption characteristic by incorporating copper ion, and such a glass is useful as a color correction filter material for a semiconductor image sensing device.

While the fluorine-containing glass is as important as described above, the problem is that fluorine volatilizes and that the glass flows back along the circumference portion of a pipe to wet that portion, so that no high-quality preforms can be produced at high yields by hot shaping, and the problem inhibits the production of preforms formed of a fluorine-containing glass, particularly, a fluorophosphate glass, by hot shaping. According to the present invention, however, surface striae, etc., are removed by etching, whereby a gate is opened for the mass-production, by hot shaping, of preforms formed of a fluorine-containing glass, particularly, a fluorophosphate glass.

A fluorophosphate glass has a relatively low glass transition temperature and is hence suitable for precision press-molding. In view of precision press-moldability and hot shaping properties, and from the viewpoint of impartation with the low-dispersion property represented by an Abbe's number (vd) of 65 or more, the fluorophosphate glass is preferably a fluorophosphate glass comprising, as essential components, Al, Ca and Sr as cation components and F and O as anion components. Particularly preferred is a fluorophosphate glass (to be referred to as “glass C” hereinafter) comprising 0 to 20% of Al(PO₃)₃, 0 to 30% of Ba(PO₃)₂, 0 to 30% of Mg (PO₃)₂, 0 to 30% of Ca(PO₃)₂, 0 to 30% of Sr(PO₃)₂, 0 to 30% of Zn(PO₃)₂, 0 to 15% of NaPO₃, 2 to 45% of AlF₃, 0 to 10% of ZrF₄, 0 to 15% of YF₃, 0 to 15% of YbF₃, 0 to 15% of GdF₃, 0 to 15% of BiF₃, 0 to 10% of LaF₃, 0 to 20% of MgF₂, 2 to 45% of CaF₂, 2 to 45% of SrF₂, 0 to 20% of ZnF₂, 0 to 30% of BaF₂, 0 to 10% of LiF, 0 to 15% of NaF, 0 to 15% of KF, 0 to 5% of Li₂O, 0 to 5% of Na₂O, 0 to 5% of K₂O, 0 to 5% of MgO, 0 to 5% of CaO, 0 to 5% of SrO, 0 to 5% of BaO and 0 to 5% of ZnO.

The above compositional ranges will be explained in detail below.

Al(PO₃)₃ is a component for constituting the network structure of the glass and is the most important component for improving the glass in weather resistance. However, when the content of Al(PO₃)₃ exceeds 20%, the glass is degraded in thermal stability, and the liquidus temperature and the optical properties (dispersion is increased) are degraded to a great extent, so that it is preferred to limit the content of Al(PO₃)₃ to 20% or less. The content of Al(PO₃)₃ is more preferably in the range of 0.5 to 15%.

Like Al(PO₃)₂, the components Ba(PO₃)₂, Mg(PO₃)₂, Ca(PO₃)₂ and Sr(PO₃)₂ are components for constituting the glass network structure and at the same time are important components for improving the glass in weather resistance. When the content of any one of these components exceeds 30%, not only the dispersion of the glass is increased, but also the glass is degraded in weather resistance due to an increase in P₂O₅. The content of each of these components is therefore preferably limited to 30% or less. The content of each of Ba(PO₃)₂, Mg(PO₃)₂, Ca(PO₃)₂ and Sr(PO₃)₂ is more preferably in the range of 0 to 25%. For obtaining desired optical constants, it is preferred to limit the total content of the above components (Mg(PO₃)₂+Ca(PO₃)₂+Sr(PO₃)₂+Ba(PO₃)₂) to 35% or less, and it is more preferred to limit the above total content to 32% or less.

Zn(PO₃)₂ is important as a component for improving the glass in stability. However, when the content of Zn(PO₃)₂ exceeds 30%, the dispersion of the glass is increased, and the glass is degraded in durability. It is therefore desirable to adjust the content of Zn(PO₃)₂ to 30% or less. NaPO₃ is a component for improving the glass in stability and improving the glass in optical properties. However, when the content of NaPO₃ exceeds 15%, the glass is degraded in durability. It is therefore desirable to limit the content of NaPO₃ to 15% or less.

AlF₃ is a component for improving the glass in stability and forming a lower-dispersion glass. However, when the content of AlF₃ is greater than 45%, the glass is greatly degraded in stability, and the glass is poor in meltability. On the other hand, when the above content is less than 2%, no intended optical properties are obtained. It is therefore preferred to limit the content of AlF₃ to the range of 2 to 45%, and it is more preferred to limit the above content to the range of 4 to 40%. ZrF₄ is a component for constituting the glass network structure and is a component for improving the glass in stability and also improving the glass in durability. When the content of ZrF₄ exceeds 10%, necessary optical properties can be no longer obtained, and excess introduction thereof degrades the glass in stability, so that it is desirable to limit the content of ZrF₄ to 10% or less.

YF₃, YbF₃, GdF₃, BiF₃ and LaF₃ highly effectively improve the glass in devitrification resistance when added in a small amount. When the contents of YF₃, YbF₃, GdF₃, BiF₃ and LaF₃ exceed 15%, 15%, 15%, 15% and 10%, respectively, the glass is destabilized on the contrary and is liable to devitrify, so that it is desirable to limit the content of each of these components to 0 to 15%, 0 to 15%, 0 to 15%, 0 to 15% and 0 to 10%, respectively. More preferably, the content of YF₃ is 0 to 12%, the content of YbF₃ is 0 to 12%, the content of GdF₃ is 0 to 10%, the content of BiF₃ is 0 to 10%, and the content of LaF₃ is 0 to 7%. The content of GdF₃ is still more preferably 0 to 8%.

MgF₂ is a component for forming a lower-dispersion glass. However, when the content of MgF₂ exceeds 20%, the glass is destabilized, so that it is desirable to limit the content of MgF₂ to 20% or less.

CaF₂ and SrF₂ are components required for forming a lower-dispersion glass while the devitrification resistance is maintained. Particularly, CaF₂ plays a role in strengthening the glass structure in combination with AlF₃ and is indispensable for stabilization of the glass. Further, when the content of each of CaF₂ and SrF₂ is less than 2%, such a content cannot be said to be sufficient in view of an improvement in stabilization of the glass, and it is difficult to obtain predetermined optical constants. Further, when the content of each of CaF₂ and SrF₂ exceeds 45%, the glass may be destabilized, so that the content of each of CaF₂ and SrF₂ is therefore preferably in the range of 2 to 45%. More preferably, the content of CaF₂ is in the range of 5 to 40%, and the content of SrF₂ is in the range of 3 to 35%.

ZnF₂ has an effect on stabilization of the glass and an increase in durability of the glass. However, when the content of ZnF₂ exceeds 20%, the glass is degraded in stability, so that it is desirable to limit the content of ZnF₂ to 20% or less.

BaF₂ has an effect on an improvement in durability and formation of a lower-dispersion glass. However, when the content of BaF₂ exceeds 30%, the glass is degraded in stability, so that it is desirable to limit the content of BaF₂ to 30% or less.

LiF, NaF and KF have an effect on improvements in devitrification resistance and dispersion properties of the glass when added in a small amount. When they are introduced to excess, the glass is sharply degraded in stability and is also degraded in durability, so that it is preferred to limit the contents to LiF, NaF and KF to 0 to 10%, 0 to 15% and 0 to 15%, respectively. More preferably, the contents of LiF, NaF and Ff are 0 to 5%, 0 to 10% and 0 to 10%, respectively.

While Li₂O, Na₂O, K₂O, MgO, CaO, SrO, BaO and ZnO are not essential components in the present invention, they have an effect on improvements of the glass in stability, weather resistance and durability when added in a small amount. When introduced to excess, they may degrade the glass in meltability or degrade the glass in dispersion properties, so that the contents of these components are preferably limited as follows: 0 to 5% of Li₂O, 0 to 5% of Na₂O, 0 to 5% of K₂O, 0 to 5% of MgO, 0 to 5% of CaO, 0 to 5% of CaO, 0 to 5% of SrO, 0 to 5% of BaO, and 0 to 5% of ZnO. More preferably, the above contents are limited as follows: 0 to 4% of Li₂O, 0 to 4% of Na₂O, 0 to 4% of K₂O, 0 to 4% of MgO, 0 to 4% of CaO, 0 to 4% of SrO, 0 to 4% of BaO, and 0 to 4% of ZnO.

In addition to the above components, a small amount of compounds of Cl, Br, etc., may be introduced for adjusting defoaming or optical constants. In view of influences on the environment, it is desirable to introduce none of a lead compound and an arsenic compound.

Further, a copper-containing fluorophosphate glass is preferred as a glass for use in the present invention. When copper oxide is introduced to a fluorophosphate glass as a base, the fluorophosphate glass can be imparted with near infrared absorption characteristics. A preform formed of the above copper-containing fluorophosphate glass is precision press-molded, whereby an optical element having near infrared absorption characteristics can be produced. The glass as a base includes the above glass A for example. The above optical element can be also used as a color correction filter for a semiconductor image sensing device of CCD, CMOS, and the like. For example, the above preform formed of a copper-containing fluorophosphate glass can be molded in the form of a thin plate to obtain the above filter, a diffraction grating is formed to obtain an optical low pass filter, the above preform is molded into a lens to obtain an optical element that works as both a color correction filter and a lens, and there can be also obtained an optical element that works as an optical low pass filter having the function of a diffraction grating imparted on a lens surface, a lens and a color correction filter.

The glass C is stable as a glass. A melt of the glass is cast into a 40×70×15 mm mold (die) made of carbon and gradually cooled to its glass transition temperature and the glass is annealed at the glass transition temperature for 1 hour and allowed to cool to room temperature. Even in this case, no crystal observable through a microscope is precipitated.

When a glass gob is shaped from the glass C, the glass C is melted and refined at a temperature of 800 to 1,100° C., a molten glass thereof is caused to flow out of a flow pipe made of a platinum alloy in atmosphere, in a dry atmosphere or in an atmosphere containing a mixture of a rare gas such as argon or an inert gas such as nitrogen gas with oxygen gas (in this case, the ratio of oxygen is preferably 1 to 50% by volume), and the glass gob is produced by the above float shaping method.

When the glass having the above composition is used, there can be produced a preform formed of an optical glass having optical constants represented by a refractive index (nd) of 1.42 to 1.6 and an Abbe's number (vd) of 65 or more, preferably 65 to 97. Further, for more improving the precision press-moldability of the above glass, it is preferred to use the above glass that has a sag temperature (Ts) of 500° C. or lower.

Most of fluorine-containing glasses such as a fluorophosphate glass exhibit large abrasion degrees. The abrasion degree FA refers to an amount defined in “Method of measuring abrasion degree of optical glass” of Japan Optical Glass Industrial Society Standard JOGIS10-1994. With an increase in abrasion degree F_{A} of a glass, it is more difficult to obtain a smooth surface of the glass by mechanical grinding and polishing, or a glass having a large abrasion degree F_{A} may be broken during grinding or polishing and is hence not suitable for grinding and polishing. According to the present invention, however, there can be produced a preform that is optically homogeneous and of which the entire surface is smooth, without applying mechanical grinding and polishing. The glass to which the present invention is more preferably applied is a glass having an abrasion degree F_{A} of 200 or more, and the glass to which the present invention is still more preferably applied is a glass having an abrasion degree F_{A} of 300 or more. While that upper limit of the abrasion degree F_{A} which is preferred is not specially limited, an abrasion degree F_{A} of 600 or less can be employed as a criterion.

Further, it is preferred to use a glass having high weather resistance represented by a haze value of 8% or less found after the glass is left under conditions including a temperature of 60° C. and a relative humidity of 90% for 350 hours. When a glass having high weather resistance is used, the surface of a preform produced by the above production process can be maintained under excellent conditions for a long period of time, and an optical element produced from the above preform can be also improved in weather resistance. The above haze value refers to an amount defined in “Method of measuring chemical durability of optical glass (Surface method)” of Japan Optical Glass Industrial Society Standard JOGIS07-1975.

The etching of a glass gob will be explained below. The etching of a glass gob may be dry etching using an etching gas or may be wet etching using an etching solution. For uniformly removing the entire surface of a glass gob, preferably, the etching is carried out by immersing the glass gob in an etching solution, preferably, by immersing the entire glass gob in an etching solution.

One of advantages of the etching over mechanical grinding and polishing is that a constant depth of the etching (depth of a portion removed by the etching) can be attained under constant etching conditions. Due to a combination of the above advantage with the advantage of the hot shaping, high-quality preforms having high weight accuracy can be produced from a molten glass. For example, the step of separating a molten glass gob from a molten glass that is flowing out of a pipe and forming a glass gob is repeated to prepare a plurality of glass gobs having a constant weight. The above plurality of glass gobs are etched under constant conditions to produce preforms having a constant weight. Under constant etching conditions, a constant amount of glass is removed from each glass gob, so that a number of preforms having a constant weight each can be easily produced. The above procedures can be easily carried out as follows. The time period for which the glass gobs are or the glass gob is immersed in an etching solution is set so that it is a constant period of time, or a plurality of the glass gobs as one set are immersed in an etching solution and taken out of the etching solution after a predetermined period of time. In this case, the temperature of the etching solution has a great effect on the etching rate. For producing preforms having high weight accuracy without impairing the high weight accuracy of the glass fobs, it is required to control the temperature of the etching solution accurately so that the temperature of the etching solution can be maintained at a constant temperature.

The etching solution can be selected from an acid solution or an alkali solution. Examples of the above acid solution include solutions of HNO₃, HCl, H₂SO₄, HF, H₂SiF₆, etc., and a mixture solution containing at least two members selected from HNO₃, HCl, H₂SO₄, HF and H₂SiF₆. Examples of the above alkali solution include solutions of NaOH, KOH, Na₂CO₃, etc., and a mixture solution containing at least two members selected from NaOH, KOH and Na₂CO₃. The above acid solution or alkali solution may contain an auxiliary such as a chelating agent, a surfactant, or the like. When a chelating agent is added to the etching solution, the chelating agent can capture metal ion generated by the dissolving of glass during the etching, so that the etching can be more uniformly carried out. When a glass containing an alkaline earth metal oxide (e.g., the glass 1 and glass 2) is etched with an H₂SO₄ solution, a sparingly soluble salt (sulfate such as BaSO₄, etc.) is generated on the glass gob surface due to a reaction between the etching solution and the glass. When such a salt precipitates on the glass gob surface, the proceeding of the etching is hampered, so that it is desirable to stir the etching solution.

On the other hand, even when the above glass contains an alkaline earth metal oxide such as BaO, and when it is etched with an HCl solution, an alkaline earth metal chloride is dissolved in the etching solution since the alkaline earth metal chloride is soluble in water, and it does not easily hamper the proceeding of the etching. From the above viewpoint, an HCl solution is more preferred as an acid solution, and an HNO₃ solution is preferred as one next thereto. Meanwhile, the formation of a sparingly soluble salt may be also used. Since a sparingly soluble salt precipitates in the solution, the etching solution is saturated, so that the etching rate is not easily decreased. Further, the precipitate can be removed, and in such a case, the remaining solution can be again and again used as an etching solution.

When a fluorophosphate glass containing an alkaline earth metal, such as the glass C, is etched with an H₂SO₄ solution, a sparing soluble salt (sulfate such as BaSO₄, etc.) is generated on the glass gob surface due to a reaction between the etching solution and the glass. When such a salt precipitates on the glass gob surface, the proceeding of the etching is hampered, so that it is desirable to stir the etching solution.

On the other hand, when a fluorophosphate glass containing an alkaline earth metal is etched with an HCl solution, an alkaline earth metal chloride is dissolved in the etching solution since the alkaline earth metal chloride is soluble in water, and it does not easily hamper the proceeding of the etching. From the above viewpoint, an HCl solution is more preferred as an acid solution, and an HNO₃ solution is preferred as one next thereto.

Meanwhile, the formation of a sparingly soluble salt may be also used. Since a sparingly soluble salt precipitates in the solution, the etching solution is saturated, so that the etching rate is not easily decreased. Further, the precipitate can be removed, and in such a case, the remaining solution can be again and again used as an etching solution.

In an HCl solution or HNO₃ solution, the etching rate is increased, and in an H₂SO₄ solution, the etching rate is decreased. While these data are used, the etching rate can be adjusted on the basis of a mixture solution containing solutions that attain different etching rates, such as a mixture solution of HCl and H₂SO₄, a mixture solution of HNO₃ and H₂SO₄ or a mixture solution of HCl, HNO₃ and H₂SO₄.

After the thus-produced preform is washed, a thin film such as a mold release film may be formed on the surface of the preform as required. Examples of the mold release film include a carbon-containing film, a self-organizing film, and the like.

(2) The production processes 2-a and 2-b will be explained below.

The production process 2-a is a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.65 or more and an Abbe's number (vd) of 35 or less and containing P₂O₅, Nb₂O₅ and Li₂O.

Further, the production process 2-b is a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass comprising, by mol %, 15 to 45% of P₂O₅, 3 to 35% of Nb₂O₅, 2 to 35% of Li₂O, 0 to 20% of TiO₂, 0 to 40% of WO₃, 0 to 20% of Bi₂O₃, 0 to 30% of B₂O₃, 0 to 25% of BaO, 0 to 25% of ZnO, 0 to 20% of MgO, 0 to 20% of CaO, 0 to 20% of SrO, 0 to 30% of Na₂O, 0 to 30% of K₂O, provided that the total content of Li₂O, Na₂O and K₂O is 45% or less, 0 to 15% of Al₂O₃, 0 to 15% of SiO₂, 0 to 10% of La₂O₃, 0 to 10% of Gd₂O₃, 0 to 10% of Yb₂O₃, 0 to 10% of ZrO₂ and 0 to 10% of Ta₂O₅.

In the production processes 2-a and 2-b, the method of separating a glass gob from a molten glass, the method of shaping the separated glass gob, the method of etching the glass gob and the form of an obtained preform are as explained with regard to the production processes 1-a to 1 -e. Further, the composition and properties of the glass for use in the production processes 2-a and 2-b are as explained with regard to the glass A-1 and the glass A-2 in the production processes 1-a to 1-e.

(3) The production processes 3-a to 3-d will be explained below.

The production process 3-a is a process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.75 or more and an Abbe's number (vd) of 25 to 58 and containing B₂O₃ and La₂O₃.

The production process 3-b is a process for producing a precision press-molding preform from a molten glass, wherein the molten glass is shaped into a glass gob and the entire surface of said glass gob is etched to produce a precision press-molding formed of an optical glass having a predetermined weight, and further wherein said optical glass is an optical glass containing, by mol %, 15 to 60% of B₂O₃, 0 to 40% of SiO₂, 5 to 22% of La₂O₃, 0 to 20% of Gd₂O₃, 0 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15% of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂, 0 to 10% of Bi₂O₃ and 0 to 1% of Sb₂O₃.

In the production processes 3-a and 3-b, the method of separating a glass gob from a molten glass, the method of shaping the separated glass gob, the method of etching the glass gob, the form of an obtained preform, etc., are as explained with regard to the production processes 1-a to 1-e. Further, the composition and properties of the glass for use in the production processes 3-a and 3-b are as explained with regard to the glass B-1 and the glass B-2 in the production processes 1-a to 1-e.

The production process 3-c is a process for producing a precision press-molding preform formed of an optical glass containing B₂O₃, which comprises the step of etching the surface of a glass gob formed of said optical glass with an etching solution and then bringing said surface into contact with an organic solvent or the step of etching said glass gob with an etching solution that is a mixture of an acid or an alkali with an alcohol.

Further, the production process 3-d is a process for producing a precision press-molding preform formed of an optical glass containing B₂O₃, which comprises the step of etching the surface of a glass gob formed of said optical glass with an etching solution and the step of washing the etched glass gob by scrubbing.

The production processes 3-c and 3-d provide a method of highly productively producing a high-quality preform, in which an altered glass generated on the surface layer of a glass gob by the above hot shaping, an altered glass generated on the surface of a glass gob not by the hot shaping or foreign matter sticking to the surface of a glass gob is removed. When a glass gob formed of the optical glass containing B₂O₃ is etched with an etching solution, the above altered glass and foreign matter can be removed. However, a gel-like substance is formed on the glass surface due to a reaction between the etching solution and glass component(s). This substance formed cannot be removed by ultrasonic cleaning of the glass in water. The above gel-like substance is observable conspicuously in a glass composition containing SiO₂. The production processes 3-c and 3-d enables the effective removal of the above gel-like deposit (substance) or enables the effective removal of the above gel-like deposit while reducing the occurrence of the same.

The production process 3-c is a process for producing a precision press-molding preform formed of an optical glass containing B₂O₃, which comprises the step of etching the surface of a glass gob formed of said optical glass with an etching solution and then bringing said surface into contact with an organic solvent or the step of etching said glass gob with an etching solution that is a mixture of an acid or an alkali with an alcohol.

The production process 3-c includes two embodiments. The first embodiment is one in which the surface of a glass gob is etched with an etching solution and then the above surface is brought into contact with an organic solvent, and the second embodiment has the step of etching a glass gob with an etching solution containing a mixture of an acid or an alkali with an alcohol. The first and second embodiments may apply together.

The etching solution in the first embodiment and the acid or an alkali in the second embodiment can be selected from those that are explained with regard to the production processes 1-a to 1-e. The organic solvent in the first embodiment can be selected from alcohols, and the like. As an alcohol in the first and second embodiments, ethanol and isopropyl alcohol are preferred. In the first embodiment, the gel-like deposit may be removed by bringing the above surface into contact with the organic solvent and washing the same with the organic solvent, or the gel-like deposit may be removed by bringing the above surface into contact with the organic solvent and then washing the same with a wash liquid. The wash liquid can be selected from organic solvents (e.g., ethanol, isopropyl alcohol and other alcohols) or water. When the etched glass surface and the organic solvent are brought into contact with each other, the glass may be immersed in the organic solvent, that is, the entire surface of the glass gob may be brought into contact with the organic solvent, or the organic solvent may be put on the glass. However, when the glass surface and the organic solvent are brought into contact with each other, desirably, such the contacting is carried out after the etching but before the glass surface is dried.

In the second embodiment, the formation of the gel-like deposit is decreased or prevented with an etching solution that is a mixture of an acid or an alkali with an alcohol. However, the etching solution is one that is diluted with the acid or the alcohol, so that the etching rate is decreased. When the glass gob surface layer to be removed has a large thickness or for decreasing the etching time period for improving productivity, it is preferred to employ the production process that is carried out according to the first embodiment rather than the second embodiment. In the second embodiment, there may be also employed a constitution in which the organic solvent is brought into contact with the glass surface after the etching and the gel-like deposit may be removed by washing with a washing liquid. The washing liquid can be selected from organic solvents (e.g., ethanol, isopropyl alcohol and other alcohols) or water.

In the production process 3-c, the gel-like deposit can be relatively easily removed without labor or a cost as compared with the production process 3-d to be described later, and preforms having clean surfaces can be highly productively produced. Both the combination of the etching solution with the organic solvent and the combination of the acid with the alcohol are preferably a combination of hydrochloric acid with ethanol and a combination of hydrochloric acid with isopropyl alcohol.

The production process 3-d is a process for producing a precision press-molding preform formed of an optical glass containing B₂O₃, which comprises the step of etching the surface of a glass gob formed of said optical glass with an etching solution and the step of washing the etched glass gob by scrubbing.

In the production process 3-d, the etching can be carried out in the same manner as in the first embodiment of the process 3-c. Further, for removing the gel-like deposit, preferably, the washing is carried out after the etching but before the glass surface is dried. For the scrubbing, a known method can apply.

The optical glass for use in the production processes 3-c and 3-d includes glasses explained with regard to the production process 1 and the production process 2 and glasses containing SiO₂, particularly, glasses having an SiO₂ content of 0.1 to 40%. Particularly preferred are glasses having an SiO₂ content of 1 to 40%, and glasses that are explained with regard to the production process 1 and the production process 2 and that contain SiO₂ (particularly, have the above content of SiO₂).

The production process 3-c may be combined with the production process 3-a or 3-b, or may be combined with the production processes 3-a and 3-b. The production process 3-d may be combined with the production process 3-a or 3-b, or may be combined with the production processes 3-a and 3-b.

The glass gob in each of the production processes 3-c and 3-d shall not be limited to those obtained directly from a molten glass by shaping. For example, there may be used a glass gob produced through the steps of cutting or splitting a shaped glass material such as a plate-like glass or glass block formed of an optical glass to prepare a glass piece and grinding and polishing the thus-obtained glass piece. In this case, preferably, the weight accuracy explained with regard to the production processes 1-a to 1-e applies to the weight accuracy of the glass gob.

Preforms produced by the production processes 3-c and 3-d as described above are excellent in surface and internal qualities like preforms produced by the production processes 3-a and 3-b.

After the thus-produced preform is washed, a thin film such as a mold release film may be formed on the surface thereof as required. Examples of the mold release film include a carbon-containing film, a self-organizing film, and the like.

(4) The production process 4-a will be explained below.

The production process 4-a is a process for producing a precision press-molding preform from a molten glass, which comprises shaping the molten glass that is a fluorine-containing glass into a glass gob, etching said glass gob to remove a surface layer of the glass gob, and thereby producing the precision press-molding preform.

In the production process 4-a, the method of separating the glass gob from the molten glass, the method of shaping the separated glass gob, the method of the etching, the form of the obtained preform, etc., are as explained with the production processes 1-a to 1-e. The fluorine-containing glass and preferred compositions and properties of the glass for use in the production process 4-a are as explained with regard to the production processes 1-a to 1-e.

[Process for Producing Optical Element]

The process for producing an optical element, provided by the present invention, comprises the step of precision press-molding a precision press-molding preform produced by any one of the above production processes.

The precision press-molding is also called “mold optics molding” and has been already well known in this art. That surface of an optical element which transmits, refracts, diffracts or reflects light is called “optical-function surface”. For example, when the optical element is supposed to be a lens, an aspherical surface of an aspherical lens or a spherical surface of a spherical lens corresponds to the optical-function surface. According to the precision press-molding, the optical-function surface can be formed by press molding, in which the molding surface of a press mold is precisely transferred to a glass. That is, mechanical processing procedures such as grinding, polishing, etc., are not required for finishing the optical-function surface.

According to the present invention, there can be produced various lenses such as a spherical lens, an aspherical lens, a microlens, etc., and various optical elements such as a diffraction grating, a lens with a diffraction grating, a lens array, a prism, etc., and from the viewpoint of use, there can be produced various optical elements such as a lens for constituting the image-sensing optical system of a digital camera or a film-equipped camera, an image-sensing lens for a cellular phone with a camera and lenses for introducing light for data reading and/or data writing in optically recording media including CD and DVD.

The above optical elements may be provided with an optical thin film such as anti-reflection film, a total reflection film, a partial reflection film, a film having spectral characteristics, or the like as required. Examples of the press mold for use in the precision press-molding method include known press molds, such as a mold prepared by forming a mold release film on the molding surface of a mold material such as a silicon carbide or refractory material, while a press mold made from silicon carbide is preferred. The mold release film can be selected from a carbon-containing film, a noble metal alloy film, or the like, while a carbon-containing film is preferred in view of durability and a cost.

In the precision press-molding method, it is preferred to employ a non-oxidizing gas atmosphere as an atmosphere for maintaining the molding surface of a press mold under excellent conditions. The non-oxidizing gas preferably includes nitrogen and a mixture gas of nitrogen with hydrogen.

The pressure by the press can be adjusted as required, while a pressure in the range of approximately 5 to 15 MPa can be employed as a criterion. Further, the time period for pressing can be adjusted as required, while a time period for 10 to 300 seconds can be employed as a criterion.

The precision press-molding method suitable for the production of the optical element of the present invention will be explained below.

(Precision Press-Molding Method 1)

This precision press-molding method comprises introducing the above preform into a press mold and heating the above press mold and the preform together to precision press-mold the preform (to be referred to as “precision press-molding method 1” hereinafter).

In the precision press-molding 1, preferably, the press mold and the above preform are heated together to a temperature at which the glass constituting the preform exhibits a viscosity of 10⁶ to 10¹² dPa·s, for the precision press-molding.

Further, desirably, the precision press-molded product is cooled to a temperature at which the above glass exhibits a viscosity of 10¹² dpa·s or higher, more preferably 10¹⁴ dPa·s or higher, still more preferably 10¹⁶ dPa·s or higher, before the precision press-molded product is taken out from the press mold.

Under the above conditions, the form of molding surface of the press mold can be precisely transferred to the glass, and the precision press-molded product can be taken out of the press mold without causing any deformation.

(Precision Press-Molding Method 2)

This method comprises introducing a preheated preform into a press mold and precision press-molding the preform, that is, separately preheating the press mold and the preform, introducing the pre-heated preform into the press mold and precision press-molding the preform (to be referred to as “precision press-molding method 2” hereinafter).

According to the above method, the above preform is heated in advance before it is introduced into the mold, so that there can be produced optical elements free of any surface defect and excellent in surface accuracy while the cycle time can be decreased.

Preferably, the temperature for preheating the press mold is set at a temperature lower than the temperature for preheating the preform. When the temperature for preheating the press mold is set at a lower temperature as described above, the abrasion of the above mold can be decreased.

Further, since it is not required to heating the preform in the press mold, the number of press molds used can be also decreased.

In the precision press-molding method 2, preferably, the above preform is preheated to a temperature at which the glass constituting the preform exhibits a viscosity of 10⁹ dPa·s or less, more preferably 10⁵ to 10⁹ dPa·s.

Further, it is preferred to preheat the above preform while it is caused to float, and it is more preferred to preheat the preform to a temperature at which the glass constituting the preform exhibits a viscosity of 10^{5.5} to 10⁹ dPa·s, more preferably 10^{5.5} or more but less than 10⁹ dPa·s.

Further, preferably, the cooling of the glass is started simultaneously with the start of the pressing or during the pressing.

The temperature of the press mold is adjusted to a temperature that is lower than the above temperature for preheating the preform, and as a criterion, there can be employed a temperature at which the above glass exhibits a viscosity of 10⁹ to 10¹² dPa·s.

In the above method, preferably, the precision press-molded product is taken out of the press mold after it is cooled to a temperature at which the above glass has a viscosity of 10¹² dPa·s or higher.

The optical element obtained by the precision press-molding is taken out of the press mold, and it is gradually cooled as required. Further, when a lens is formed, the precision press-molded product may be processed for centering and edging. Further, an optical thin film may be formed on the surface of the product as required.

In the above manner, optical elements formed of the precision press-molding preform of the present invention each can be highly productively produced.

### EXAMPLES

The present invention will be explained further in detail with reference to Examples, while the present invention shall not be limited by these Examples.

### Examples

(1) Preparation of optical glass containing P₂O₅, Nb₂O₅ and Li₂O

Tables 1 to 5 show compositions of glass materials for producing preforms and properties of each of them such as a refractive index (nd), Abbe's number (vd), glass transition temperature (Tg), sag temperature (Ts) and liquidus temperature (L.T.). Samples for measurements with regard to the above properties were prepared as follows. Oxides, fluorides, hydroxides, carbonates and nitrates as materials corresponding to glass components were weighed so as to give a composition after formed into a glass and fully mixed. These materials were poured into a platinum crucible, and in an electric furnace, the materials in the platinum crucible were melted, refined and stirred at a temperature in the range of 1,50° C. to 1,200° C. to homogenize them. The thus-formed glass was cast into a mold preheated to a proper temperature, then, cooled to its glass transition temperature and, immediately thereafter, placed in an annealing furnace and gradually cooled to room temperature, to obtain each sample.

Each of the thus-obtained optical glasses was measured for a refractive index (nd), an Abbe's number (vd), a glass transition temperature (Tg), a sag temperature (Ts), a liquidus temperature (L.T.) and a viscosity at a liquidus temperature (liquidus viscosity) as follows. Tables 1 to 5 shows the results.

(a) Refractive Index (nd) and Abbe's Number (vd)

An optical glass obtained at a temperature decrease ratio of −30° C./hour for gradually cooling was measured.

(b) Glass Transition Temperature (Tg) and Sag Temperature (Ts)

Measured with an apparatus for thermomechanical analysis supplied by Rigaku Corporation at a temperature elevation rate of 4° C./minute.

(c) Liquidus Temperature (L.T.)

A sample was held in a devitrification testing furnace with a temperature gradient of 400 to 1,150° C. for 1 hour, and observed through a microscope of 80 magnifications for a presence or absence of a crystal, to measure a liquidus temperature.

(d) Liquidus Viscosity

Measured for a viscosity at a liquidus temperature of a glass according to a rotating cylinder method based on “JIS Z 8803-1991 ‘Method of measuring liquid for viscosity’ 8. Viscosity measurement with single cylindrical rotation viscometer”.

TABLE 1

| | | Run No. | | | | | | |
|---|---|---|---|---|---|---|---|---|
| | | 1 | 2 | 3 | 4 | 5 | 6 | 7 |
| Composition (mol %) | P₂O₅ | 23.94 | 23.88 | 24.00 | 24.00 | 24.00 | 22.00 | 20.00 |
| | B₂O₃ | 2.99 | 2.97 | 3.00 | 3.00 | 4.00 | 3.00 | 3.00 |
| | SiO₂ | | | | | | | |
| | Li₂O | 11.95 | 8.90 | 12.00 | 16.00 | 18.00 | 16.00 | 15.00 |
| | Na₂O | 9.34 | 12.82 | 7.00 | 10.00 | 14.00 | 18.00 | 20.00 |
| | K₂O | 1.99 | 1.98 | 2.00 | 2.00 | 2.00 | 8.00 | 7.00 |
| | BaO | 9.96 | 7.91 | 11.00 | 5.00 | | | 2.00 |
| | ZnO | 4.98 | 6.92 | 6.50 | 5.00 | | | |
| | SrO | | | | | | | |
| | CaO | | | | | | | |
| | Al₂O₃ | | | | | | | |
| | Y₂O₃ | | | | | | | |
| | Bi₂O₃ | | | | | | | |
| | TiO₂ | 4.98 | 4.95 | 4.50 | 5.00 | 8.00 | 5.00 | 5.00 |
| | Nb₂O₅ | 17.92 | 18.79 | 18.00 | 18.00 | 20.00 | 18.00 | 18.00 |
| | WO₃ | 11.95 | 10.88 | 12.00 | 12.00 | 10.00 | 10.00 | 10.00 |
| | Total | 100 | 100 | 100 | 100 | 100 | 100 | 100 |
| Properties | Tg (° C.) | 503 | 505 | 507 | 486 | 493 | 446 | 441 |
| | Ts (° C.) | 556 | 559 | 554 | 538 | 546 | 495 | 496 |
| | nd | 1.84509 | 1.84521 | 1.85050 | 1.84151 | 1.84937 | 1.80851 | 1.81741 |
| | νd | 23.54 | 23.26 | 23.66 | 23.25 | 21.96 | 23.50 | 23.92 |

TABLE 2

| | | Run No. | | | | | |
|---|---|---|---|---|---|---|---|
| | | 8 | 9 | 10 | 11 | 12 | 13 |
| Composition (mol %) | P₂O₅ | 20.00 | 20.00 | 20.00 | 17.00 | 17.00 | 18.00 |
| | B₂O₃ | 5.00 | 5.00 | 5.00 | 5.00 | 500 | 5.00 |
| | SiO₂ | | | | | | |
| | Li₂O | 12.00 | 12.00 | 12.00 | 12.00 | 12.00 | 12.00 |
| | Na₂O | 10.00 | 10.00 | 10.00 | 10.00 | 10.00 | 10.00 |
| | K₂O | 3.00 | 3.00 | 3.00 | 3.00 | 3.00 | 3.00 |
| | BaO | 15.00 | 15.00 | 15.00 | 18.00 | 16.00 | 10.00 |
| | ZnO | | | | | | 7.00 |
| | SrO | | | | | | |
| | CaO | | | | | | |
| | Al₂O₃ | | | | | 2.00 | |
| | Y₂O₃ | | | | | | |
| | Bi₂O₃ | | | | | | |
| | TiO₂ | 5.00 | 5.00 | 5.00 | 5.00 | 5.00 | 5.00 |
| | Nb₂O₅ | 20.00 | 15.00 | 10.00 | 12.00 | 12.00 | 12.00 |
| | WO₃ | 10.00 | 15.00 | 20.00 | 18.00 | 18.00 | 18.00 |
| | Total | 100 | 100 | 100 | 100 | 100 | 100 |
| Properties | Tg (° C.) | 508 | 492 | 475 | 466 | 463 | 455 |
| | Ts (° C.) | 561 | 541 | 528 | 519 | 512 | 502 |
| | nd | 1.85952 | 1.83263 | 1.80631 | 1.82606 | 1.82548 | 1.83019 |
| | νd | 23.68 | 24.89 | 26.34 | 26.09 | 25.91 | 24.78 |

TABLE 3

| | | Run No. | | | | | | |
|---|---|---|---|---|---|---|---|---|
| | | 14 | 15 | 16 | 17 | 18 | 19 | 20 |
| Composition (mol %) | P₂O₅ | 20.00 | 24.00 | 20.00 | 17.69 | 16.46 | 16.85 | 16.08 |
| | B₂O₃ | 5.00 | 3.00 | 8.00 | 12.65 | 7.05 | 7.22 | 6.89 |
| | SiO₂ | | | | | | | |
| | Li₂O | 13.00 | 12.00 | 10.00 | 12.65 | 14.11 | 12.04 | 13.78 |
| | Na₂O | 9.00 | 9.00 | 10.00 | 7.17 | 9.01 | 6.82 | 8.81 |
| | K₂O | 3.00 | 2.00 | 5.00 | 2.53 | 2.35 | 2.41 | 2.30 |
| | BaO | 6.00 | 10.00 | 20.00 | 16.19 | 15.05 | 15.41 | 14.70 |
| | ZnO | 7.00 | 5.00 | | | | | |
| | SrO | 2.00 | | | | | | |
| | CaO | | | | | | | |
| | Al₂O₃ | | | | | | | |
| | Y₂O₃ | | | 2.00 | | | | |
| | Bi₂O₃ | | | | | | | |
| | TiO₂ | | 5.00 | | | | | |
| | Nb₂O₅ | 17.50 | 18.00 | 20.00 | 15.94 | 7.76 | 15.17 | 5.28 |
| | WO₃ | 17.50 | 12.00 | 5.00 | 15.18 | 28.21 | 24.08 | 32.16 |
| | Total | 100 | 100 | 100 | 100 | 100 | 100 | 100 |
| Properties | Tg (° C.) | 467 | 495 | 507 | 495 | 456 | 495 | 452 |
| | Ts (° C.) | 512 | 549 | 558 | 540 | 495 | 541 | 491 |
| | nd | 1.84745 | 1.85241 | 1.82932 | 1.83378 | 1.81143 | 1.87201 | 1.80764 |
| | νd | 24.01 | 23.40 | 27.40 | 25.81 | 27.46 | 23.92 | 27.75 |

TABLE 4

| | | Run No. | | | | | | |
|---|---|---|---|---|---|---|---|---|
| | | 21 | 22 | 23 | 24 | 25 | 26 | 27 |
| Composition (mol %) | P₂O₅ | 15.71 | 24.00 | 24.00 | 24.00 | 23.00 | 23.00 | 24.00 |
| | B₂O₃ | 6.74 | 3.00 | 4.20 | 4.00 | 4.00 | 4.00 | 4.00 |
| | SiO₂ | | | | | | | |
| | Li₂O | 8.61 | 22.00 | 21.00 | 20.00 | 18.00 | 18.00 | 18.00 |
| | Na₂O | 13.47 | 11.00 | 13.00 | 11.00 | 13.00 | 18.00 | 15.00 |
| | K₂O | 2.25 | 2.00 | 2.00 | 2.00 | 2.00 | | 2.00 |
| | BaO | 14.37 | 3.00 | 3.00 | 3.00 | | 2.00 | |
| | ZnO | | 3.00 | 3.00 | 2.00 | 2.00 | 2.00 | 2.00 |
| | SrO | | | | | | | |
| | CaO | | | | | | | |
| | Al₂O₃ | | | | | | | |
| | Y₂O₃ | | | | | | | |
| | Bi₂O₃ | | | | 2.00 | 6.00 | 5.00 | 6.00 |
| | TiO₂ | | 6.00 | 6.00 | 5.00 | 5.00 | 5.00 | 5.00 |
| | Nb₂O₅ | 2.92 | 18.00 | 18.00 | 19.00 | 19.00 | 18.00 | 18.00 |
| | WO₃ | 35.93 | 8.00 | 5.80 | 8.00 | 8.00 | 5.00 | 6.00 |
| | Total | 100 | 100 | 100 | 100 | 100 | 100 | 100 |
| Properties | Tg (° C.) | 448 | 480 | 475 | 466 | 448 | 443 | 442 |
| | Ts (° C.) | 489 | 525 | 520 | 519 | 497 | 492 | 493 |
| | nd | 1.80397 | 1.82121 | 1.80500 | 1.84541 | 1.88863 | 1.85136 | 1.86026 |
| | νd | 27.98 | 24.10 | 25.40 | 23.15 | 21.73 | 21.86 | 22.61 |
| | Liquidus | — | — | — | 900 | — | — | 920 |
| | temperature | | | | | | | |
| | (LT) [° C.] | | | | | | | |
| | Viscosity at | — | — | — | 5.2 | — | — | 1.7 |
| | liquidus | | | | | | | |
| | temperature | | | | | | | |
| | (dPa · s) | | | | | | | |

TABLE 5

| | | Run No. | | | | | | |
|---|---|---|---|---|---|---|---|---|
| | | 28 | 29 | 30 | 31 | 32 | 33 | 34 |
| Composition (mol %) | P₂O₅ | 24.00 | 24.00 | 25.00 | 24.00 | 24.00 | 24.00 | 24.00 |
| | B₂O₃ | 4.00 | 4.00 | 4.00 | 6.00 | 6.00 | 6.00 | 4.00 |
| | SiO₂ | | | | | | | 2.00 |
| | Li₂O | 20.00 | 18.00 | 21.00 | 20.00 | 18.00 | 21.00 | 21.00 |
| | Na₂O | 13.00 | 11.00 | 12.00 | 13.00 | 15.00 | 12.00 | 12.00 |
| | K₂O | 2.00 | 2.00 | 2.00 | 2.00 | 2.00 | 2.00 | 2.00 |
| | BaO | 2.00 | 2.00 | 1.00 | 2.00 | 2.00 | 1.00 | 1.50 |
| | ZnO | 2.00 | | 1.00 | 2.00 | 2.00 | | |
| | SrO | | | | | | | |
| | CaO | | | | | | | |
| | Al₂O₃ | | | | | | | |
| | Y₂O₃ | | | | | | | |
| | Bi₂O₃ | 4.00 | 8.00 | 4.00 | 3.00 | 3.00 | 4.00 | 4.00 |
| | TiO₂ | 5.00 | 6.00 | 5.00 | 5.00 | 5.00 | 5.50 | 6.00 |
| | Nb₂O₅ | 19.00 | 19.00 | 19.00 | 18.00 | 18.00 | 19.00 | 18.50 |
| | WO₃ | 5.00 | 6.00 | 6.00 | 5.00 | 5.00 | 5.50 | 5.00 |
| | Total | 100 | 100 | 100 | 100 | 100 | 100 | 100 |
| Properties | Tg (° C.) | 452 | 461 | 457 | 450 | 451 | 455 | 176.00 |
| | Ts (° C.) | 504 | 505 | 506 | 503 | 505 | 507 | 348.00 |
| | nd | 1.84979 | 1.90015 | 1.84980 | 1.82732 | 1.82410 | 1.85047 | 694.00 |
| | νd | 23.10 | 21.51 | 22.95 | 23.92 | 23.97 | 22.88 | 1367.00 |
| | Liquidus | 900 | — | — | 880 | — | — | — |
| | temperature | | | | | | | |
| | (LT) [° C.] | | | | | | | |
| | Viscosity at | 3.8 | — | — | 5.2 | — | — | — |
| | liquidus | | | | | | | |
| | temperature | | | | | | | |
| | (dPa · s) | | | | | | | |

(2) Preparation of Optical Glass Containing B₂O₃ and La₂O₃

Optical glasses having compositions and properties shown in Tables 6 to 12 were prepared in the same manner as in the above (1).

TABLE 6

| | | Run No. | | | | | | | |
|---|---|---|---|---|---|---|---|---|---|
| | | 35 | 36 | 37 | 38 | 39 | 40 | 41 | 42 |
| Composition | B₂O₃ | 45.69 | 46.09 | 46.55 | 44.92 | 43.33 | 41.8 | 46.15 | 46.32 |
| (mol %) | La₂O₃ | 13.36 | 13.48 | 12.93 | 12.71 | 12.50 | 12.30 | 12.82 | 12.99 |
| | Gd₂O₃ | 6.47 | 6.52 | 6.03 | 5.93 | 5.83 | 5.74 | 5.98 | 6.06 |
| | ZnO | 15.52 | 13.91 | 17.24 | 20.34 | 23.33 | 26.23 | 18.8 | 17.32 |
| | Li₂O | 3.45 | 4.35 | 3.45 | 2.54 | 1.67 | 0.82 | 2.56 | 3.46 |
| | ZrO₂ | 5.17 | 5.22 | 5.17 | 5.08 | 5.00 | 4.92 | 5.13 | 5.19 |
| | Ta₂O₅ | 3.45 | 3.48 | 3.45 | 3.39 | 3.33 | 3.28 | 3.42 | 3.46 |
| | WO₃ | 3.45 | 3.48 | 3.45 | 3.39 | 3.33 | 3.28 | 3.42 | 3.46 |
| | SiO₂ | 3.44 | 3.47 | 1.73 | 1.70 | 1.68 | 1.63 | 1.72 | 1.74 |
| | Nb₂O₅ | 0.00 | 0.00 | 0.00 | 0.00 | 0.00 | 0.00 | 0.00 | 0.00 |
| | Y₂O₃ | 0.00 | 0.00 | 0.00 | 0.00 | 0.00 | 0.00 | 0.00 | 0.00 |
| | TiO₂ | 0.00 | 0.00 | 0.00 | 0.00 | 0.00 | 0.00 | 0.00 | 0.00 |
| | Yb₂O₃ | 0.00 | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 | 100.00 |
| Properties | nd | 1.81833 | 1.81697 | 1.81719 | 1.8212 | 1.82468 | 1.82796 | 1.8184 | 1.81869 |
| | νd | 43.02 | 43.11 | 42.91 | 42.59 | 42.26 | 41.96 | 42.78 | 42.81 |
| | Tg (° C.) | 593 | 590 | 587 | 587 | 588 | 591 | 592 | 586 |
| | Ts (° C.) | 640 | 638 | 633 | 633 | 633 | 635 | 637 | 630 |
| | Liquidus | 1010 | 1020 | 990 | 1010 | 1020 | 1030 | 990 | 1000 |
| | temperature | | | | | | | | |
| | (° C.) | | | | | | | | |
| | Viscosity | 6 | 5 | 8 | 6 | 5 | 5 | 8 | 7 |
| | at | | | | | | | | |
| | liquidus | | | | | | | | |
| | temperature | | | | | | | | |
| | (dPa · s) | | | | | | | | |

TABLE 7

| | | Run No. | | | | | | |
|---|---|---|---|---|---|---|---|---|
| | | 43 | 44 | 45 | 46 | 47 | 48 | 49 |
| Composition (mol %) | B₂O₃ | 46.09 | 45.85 | 46.96 | 46.75 | 46.55 | 47.83 | 48.26 |
| | La₂O₃ | 13.04 | 13.10 | 13.48 | 13.42 | 13.36 | 13.48 | 13.04 |
| | Gd₂O₃ | 6.09 | 6.11 | 6.52 | 6.49 | 6.47 | 6.52 | 6.52 |
| | ZnO | 17.39 | 17.47 | 15.65 | 16.45 | 17.24 | 17.39 | 17.39 |
| | Li₂O | 3.48 | 3.49 | 3.48 | 3.03 | 2.59 | 2.61 | 2.61 |
| | ZrO₂ | 5.22 | 5.24 | 5.22 | 5.19 | 5.17 | 5.22 | 5.22 |
| | Ta₂O₅ | 3.48 | 3.49 | 3.48 | 3.46 | 3.45 | 3.48 | 3.48 |
| | WO₃ | 3.48 | 3.49 | 3.48 | 3.46 | 3.45 | 3.47 | 3.48 |
| | SiO₂ | 1.73 | 1.76 | 1.73 | 1.75 | 1.72 | 0.00 | 0.00 |
| | Nb₂O₅ | 0.00 | 0.00 | 0.00 | 0.00 | 0.00 | 0.00 | 0.00 |
| | Y₂O₃ | 0.00 | 0.00 | 0.00 | 0.00 | 0.00 | 0.00 | 0.00 |
| | TiO₂ | 0.00 | 0.00 | 0.00 | 0.00 | 0.00 | 0.00 | 0.00 |
| | Yb₂O₃ | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.81986 | 1.82099 | 1.82033 | 1.82085 | 1.82161 | 1.82322 | 1.82043 |
| | νd | 42.74 | 42.67 | 42.94 | 42.93 | 42.81 | 42.83 | 42.86 |
| | Tg (° C.) | 586 | 586 | 591 | 593 | 595 | 593 | 593 |
| | Ts (° C.) | 632 | 634 | 636 | 639 | 640 | 638 | 638 |
| | Liquidus | 1010 | 1020 | 1010 | 1010 | 1010 | 1010 | 1000 |
| | temperature | | | | | | | |
| | (° C.) | | | | | | | |
| | Viscosity | 6 | 6 | 6 | 6 | 6 | 6 | 7 |
| | at | | | | | | | |
| | liquidus | | | | | | | |
| | temperature | | | | | | | |
| | (dPa · s) | | | | | | | |

TABLE 8

| | | Run No. | | | | | | |
|---|---|---|---|---|---|---|---|---|
| | | 50 | 51 | 52 | 53 | 54 | 55 | 56 |
| Composition (mol %) | B₂O₃ | 48.47 | 47.88 | 47.49 | 47.11 | 47.61 | 47.74 | 47.83 |
| | La₂O₃ | 13.54 | 13.01 | 12.98 | 12.94 | 13.01 | 13.04 | 13.48 |
| | Gd₂O₃ | 6.55 | 6.50 | 6.49 | 6.47 | 6.50 | 6.52 | 5.65 |
| | ZnO | 17.47 | 17.35 | 17.30 | 17.26 | 17.35 | 17.39 | 17.39 |
| | Li₂O | 2.62 | 2.60 | 2.60 | 2.59 | 2.60 | 2.61 | 2.61 |
| | ZrO₂ | 4.37 | 5.20 | 5.19 | 5.18 | 5.20 | 5.22 | 5.22 |
| | Ta₂O₅ | 3.49 | 3.47 | 3.46 | 3.45 | 3.47 | 3.48 | 3.48 |
| | WO₃ | 3.49 | 3.99 | 4.49 | 5.00 | 4.00 | 3.48 | 3.47 |
| | SiO₂ | 0.00 | 0.00 | 0.00 | 0.00 | 0.00 | 0.00 | 0.00 |
| | Nb₂O₅ | 0.00 | 0.00 | 0.00 | 0.00 | 0.26 | 0.52 | 0.00 |
| | Y₂O₃ | 0.00 | 0.00 | 0.00 | 0.00 | 0.00 | 0.00 | 0.87 |
| | TiO₂ | 0.00 | 0.00 | 0.00 | 0.00 | 0.00 | 0.00 | 0.00 |
| | Yb₂O₃ | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.81965 | 1.82253 | 1.82456 | 1.8268 | 1.82535 | 1.82655 | 1.82237 |
| | νd | 43.02 | 42.46 | 42.15 | 41.77 | 42.15 | 42.17 | 42.85 |
| | Tg (° C.) | 592 | 592 | 592 | 591 | 594 | 593 | 593 |
| | Ts (° C.) | 637 | 638 | 638 | 638 | 638 | 638 | 640 |
| | Liquidus | 1010 | 1000 | 1000 | 1000 | 1010 | 1020 | 1000 |
| | temperature | | | | | | | |
| | (° C.) | | | | | | | |
| | Viscosity | 6 | 7 | 7 | 7 | 6 | 5 | 7 |
| | at | | | | | | | |
| | liquidus | | | | | | | |
| | temperature | | | | | | | |
| | (dPa · s) | | | | | | | |

TABLE 9

| | | Run No. | | | | | | |
|---|---|---|---|---|---|---|---|---|
| | | 57 | 58 | 59 | 60 | 61 | 62 | 63 |
| Composition (mol %) | B₂O₃ | 47.83 | 47.83 | 37.01 | 38.89 | 38.58 | 38.28 | 37.98 |
| | La₂O₃ | 13.48 | 13.48 | 12.60 | 12.70 | 12.60 | 12.50 | 12.40 |
| | Gd₂O₃ | 4.78 | 3.91 | 3.94 | 3.97 | 3.15 | 2.34 | 1.55 |
| | ZnO | 17.39 | 17.39 | 33.07 | 33.33 | 33.07 | 32.81 | 32.56 |
| | Li₂O | 2.61 | 2.61 | 0.79 | 0.00 | 0.00 | 0.00 | 0.00 |
| | ZrO₂ | 5.22 | 5.22 | 3.15 | 0.00 | 0.00 | 0.00 | 0.00 |
| | Ta₂O₅ | 3.48 | 3.48 | 3.15 | 0.00 | 0.00 | 0.00 | 0.00 |
| | WO₃ | 3.47 | 3.47 | 4.72 | 4.77 | 6.30 | 7.81 | 9.31 |
| | SiO₂ | 0.00 | 0.00 | 1.57 | 0.00 | 0.00 | 0.00 | 0.00 |
| | Nb₂O₅ | 0.00 | 0.00 | 0.00 | 3.17 | 3.15 | 3.13 | 3.10 |
| | Y₂O₃ | 1.74 | 2.61 | 0.00 | 0.00 | 0.00 | 0.00 | 0.00 |
| | TiO₂ | 0.00 | 0.00 | 0.00 | 3.17 | 3.15 | 3.13 | 3.10 |
| | Yb₂O₃ | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.82094 | 1.81963 | 1.83598 | 1.84677 | 1.84825 | 1.84631 | 1.8493 |
| | νd | 42.77 | 42.86 | 40.32 | 37.35 | 36.6 | 36.02 | 35.34 |
| | Tg (° C.) | 594 | 594 | 572 | 572 | 570 | 569 | 567 |
| | Ts (° C.) | 637 | 637 | 615 | 612 | 612 | 609 | 607 |
| | Liquidus | 1000 | 990 | — | — | — | — | — |
| | temperature | | | | | | | |
| | (° C.) | | | | | | | |
| | Viscosity | 7 | 9 | — | — | — | — | — |
| | at | | | | | | | |
| | liquidus | | | | | | | |
| | temperature | | | | | | | |
| | (dPa · s) | | | | | | | |

TABLE 10

| | | Run No. | | | | | | |
|---|---|---|---|---|---|---|---|---|
| | | 64 | 65 | 66 | 67 | 68 | 69 | 70 |
| Composition (mol %) | B₂O₃ | 36.43 | 34.88 | 35.43 | 37.60 | 39.84 | 34.35 | 32.33 |
| | La₂O₃ | 13.18 | 13.95 | 14.96 | 15.20 | 15.45 | 12.98 | 12.78 |
| | Gd₂O₃ | 2.33 | 3.10 | 3.94 | 4.00 | 4.07 | 2.29 | 2.26 |
| | ZnO | 32.56 | 32.56 | 29.92 | 27.20 | 24.39 | 32.06 | 31.58 |
| | Li₂O | 0.00 | 0.00 | 0.00 | 0.00 | 0.00 | 0.00 | 0.00 |
| | ZrO₂ | 0.00 | 0.00 | 0.00 | 0.00 | 0.00 | 0.00 | 0.00 |
| | Ta₂O₅ | 0.00 | 0.00 | 0.00 | 0.00 | 0.00 | 0.00 | 0.00 |
| | WO₃ | 9.30 | 9.31 | 9.45 | 9.60 | 9.75 | 9.17 | 9.01 |
| | SiO₂ | 0.00 | 0.00 | 0.00 | 0.00 | 0.00 | 3.05 | 6.02 |
| | Nb₂O₅ | 3.10 | 3.10 | 3.15 | 3.20 | 3.25 | 3.05 | 3.01 |
| | Y₂O₃ | 0.00 | 0.00 | 0.00 | 0.00 | 0.00 | 0.00 | 0.00 |
| | TiO₂ | 3.10 | 3.10 | 3.15 | 3.20 | 3.25 | 3.05 | 3.01 |
| | Yb₂O₃ | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.86186 | 1.87351 | 1.88063 | 1.8747 | 1.8691 | 1.85826 | 1.85466 |
| | νd | 35.19 | 34.94 | 35.09 | 35.36 | 35.63 | 35.19 | 35.19 |
| | Tg (° C.) | 567 | 570 | 577 | 581 | 588 | 569 | 571 |
| | Ts (° C.) | 607 | 611 | 618 | 623 | 629 | 609 | 611 |

TABLE 11

| | | Run No. | | | | | | |
|---|---|---|---|---|---|---|---|---|
| | | 71 | 72 | 73 | 74 | 75 | 76 | 77 |
| Composition (mol %) | B₂O₃ | 35.88 | 36.43 | 36.43 | 36.43 | 37.01 | 37.60 | 38.21 |
| | La₂O₃ | 12.98 | 13.18 | 13.18 | 13.18 | 13.39 | 13.60 | 13.82 |
| | Gd₂O₃ | 2.29 | 2.33 | 2.33 | 2.33 | 2.36 | 2.40 | 2.44 |
| | ZnO | 32.06 | 32.56 | 32.56 | 23.26 | 29.92 | 27.20 | 24.39 |
| | Li₂O | 0.00 | 0.00 | 0.00 | 0.00 | 1.57 | 3.20 | 4.88 |
| | ZrO₂ | 3.05 | 0.00 | 3.10 | 0.00 | 0.00 | 0.00 | 0.00 |
| | Ta₂O₅ | 0.00 | 1.55 | 1.55 | 0.00 | 0.00 | 0.00 | 0.00 |
| | WO₃ | 9.16 | 9.30 | 6.20 | 9.30 | 9.45 | 9.60 | 9.76 |
| | SiO₂ | 0.00 | 0.00 | 0.00 | 0.00 | 0.00 | 0.00 | 0.00 |
| | Nb₂O₅ | 1.53 | 1.55 | 1.55 | 3.10 | 3.15 | 3.20 | 3.25 |
| | Y₂O₃ | 0.00 | 0.00 | 0.00 | 0.00 | 0.00 | 0.00 | 0.00 |
| | TiO₂ | 3.05 | 3.10 | 3.10 | 12.40 | 3.15 | 3.20 | 3.25 |
| | Yb₂O₃ | 0.00 | 0.00 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.85786 | 1.85986 | 1.85786 | 1.89786 | 1.85866 | 1.85546 | 1.85226 |
| | νd | 36.59 | 35.99 | 37.39 | 29.19 | 35.49 | 35.79 | 36.09 |
| | Tg (° C.) | 567 | 567 | 567 | 591 | 559 | 551 | 543 |
| | Ts (° C.) | 607 | 607 | 607 | 631 | 599 | 591 | 583 |

TABLE 12

| | | Run No. | | | | | | |
|---|---|---|---|---|---|---|---|---|
| | | 78 | 79 | 80 | 81 | 82 | 83 | 84 |
| Composition (mol %) | B₂O₃ | 36.43 | 36.43 | 36.43 | 36.43 | 34.88 | 33.33 | 31.78 |
| | La₂O₃ | 11.63 | 11.63 | 10.08 | 7.75 | 10.85 | 10.85 | 10.85 |
| | Gd₂O₃ | 2.33 | 2.33 | 5.43 | 7.75 | 6.20 | 7.75 | 9.30 |
| | ZnO | 32.56 | 32.56 | 32.56 | 32.56 | 32.56 | 32.56 | 32.56 |
| | Li₂O | 0.00 | 0.00 | 0.00 | 0.00 | 0.00 | 0.00 | 0.00 |
| | ZrO₂ | 0.00 | 0.00 | 0.00 | 0.00 | 0.00 | 0.00 | 0.00 |
| | Ta₂O₅ | 0.00 | 0.00 | 0.00 | 0.00 | 0.00 | 0.00 | 0.00 |
| | WO₃ | 9.30 | 9.30 | 9.30 | 9.31 | 9.31 | 9.31 | 9.31 |
| | SiO₂ | 0.00 | 0.00 | 0.00 | 0.00 | 0.00 | 0.00 | 0.00 |
| | Nb₂O₅ | 3.10 | 3.10 | 3.10 | 3.10 | 3.10 | 3.10 | 3.10 |
| | Y₂O₃ | 1.55 | 0.00 | 0.00 | 0.00 | 0.00 | 0.00 | 0.00 |
| | TiO₂ | 3.10 | 3.10 | 3.10 | 3.10 | 3.10 | 3.10 | 3.10 |
| | Yb₂O₃ | 0.00 | 1.55 | 0.00 | 0.00 | 0.00 | 0.00 | 0.00 |
| | Total | 100.00 | 100.00 | 100.00 | 100.00 | 100.00 | 100.00 | 100.00 |
| Properties | nd | 1.85926 | 1.86026 | 1.85946 | 1.85766 | 1.87086 | 1.88186 | 1.89286 |
| | νd | 35.39 | 35.39 | 35.39 | 35.59 | 34.59 | 33.99 | 33.39 |
| | Tg (° C.) | 569 | 569 | 569 | 571 | 567 | 567 | 567 |
| | Ts (° C.) | 609 | 609 | 609 | 611 | 607 | 607 | 607 |

(3) Preparation of fluorine-containing Glass

Each of glass compositions used were measured for optical constants (refractive index (nd) and Abbe's number (vd)), a glass transition temperature (Tg) and a sag temperature (Ts). Tables 13 to 16 show the glass compositions and measurement results. While the optical constants very slightly change due to thermal history, it can be considered that preforms and optical elements have the same optical constants (refractive index (nd) and Abbe's number (vd)), glass transition temperatures (Ts) and sag temperatures (Ts) as those of the glass compositions.

Glasses in Runs Nos. 85 and 86 in Table 13 were measured for abrasiondegrees (F_{A}) as follows, and Table 13 shows the results. It can be assumed that glasses in Runs Nos. 87 to 104 in Tables 13 to 16 also show nearly equivalent values with respect to the abrasiondegree.

(e) Abrasiondegree (F_{A})

A sample having a measurement area of 9 cm² is held on a fixed portion 80 mm apart from the center of a flat plate (dish) made of cast iron turning horizontally at a rate of 60 turns per minute, and a lapping liquid prepared by adding 20 ml of water to 10 g of alumina abrasive grains having an average particle diameter of 20 μm is uniformly supplied for 5 minutes, to lap sample under a load of 0.80 N. The sample is measured for a mass before the lapping, and is measured for a mass after the lapping, to determine an abrasion weight m. A standard sample (BSC7) specified by Japan Optical Glass Industrial Society is similarly measured for an abrasion mass m₀, and an abrasiondegree (F_{A}) is calculated on the basis of the following expression.
F_{A}=[(m/d)/(m₀/d₀)]×100
d=specific gravity of sample,
d₀=specific gravity of standard sample (BSC7)

For making each of the above glasses, oxides, carbonates, sulfates, nitrates, fluorides, hydroxides, etc., as raw materials corresponding to components therefor, such as Al(PO₃)₃, Ba(PO₃)₂, AlF₃, YF₃, MgF₂, CaF₂, SrF₂, BaF₂, NaF, etc., were weighed so as to form a glass composition having a weight of 250 to 300 g and having component contents shown in Tables 13 to 16, and fully mixed to obtain a prepared batch. The batch was placed in a platinum crucible, and in an electric furnace maintained at 1,200 to 1,450° C., the batch was melted under heat in atmosphere, in a dry atmosphere or in an atmosphere obtained by mixing a rare gas such as argon or an inert gas such as nitrogen with 0.1 to 50% by volume of oxygen gas, for 2 to 4 hours. After melting, a molten glass was cast into a 40×70×15 mm mold (die) made of carbon, allowed to cool to a glass transition temperature, immediately thereafter placed in an annealing furnace, and annealed for approximately 1 hour. In the furnace, then, the glass was allowed to cool to room temperature. In the thus-obtained glass, no crystal observable through a microscope was precipitated.

TABLE 13

| | | Run No. | | | | |
|---|---|---|---|---|---|---|
| | | 85 | 86 | 87 | 88 | 89 |
| Composition (mol %) | Al(PO₃)₃ | 1.85 | | | 1.03 | 1.74 |
| | Ba(PO₃)₂ | 16.11 | 8.46 | 3.58 | | |
| | Ca(PO₃)₂ | | | | | |
| | Sr(PO₃)₂ | | | | | |
| | AlF₃ | 26.93 | 39.46 | 35.63 | 36.81 | 35.19 |
| | YF₃ | 0.88 | 3.01 | 1.34 | 9.33 | 8.89 |
| | MgF₂ | 11.42 | 4.96 | 7.22 | 6.82 | 6.93 |
| | CaF₂ | 19.54 | 26.09 | 29.31 | 24.34 | 24.84 |
| | SrF₂ | 23.27 | 16.92 | 18.14 | 12.09 | 12.26 |
| | BaF₂ | | 1.10 | 2.45 | 9.58 | 10.15 |
| | NaF | | | 2.33 | | |
| | KF | | | | | |
| | NaCl | | | | | |
| | Total | 100.00 | 100.00 | 100.00 | 100.00 | 100.00 |
| Properties | nd | 1.497 | 1.4565 | 1.4432 | 1.42736 | 1.43286 |
| | νd | 81.6 | 90.3 | 95.1 | 98.24 | 96.62 |
| | Tg (° C.) | 455 | 440 | 431 | 429 | 429 |
| | Ts (° C.) | 485 | 470 | 462 | 451 | 456 |
| | F_{A} | 410 | 460 | — | — | — |

TABLE 14

| | | Run No. | | | | |
|---|---|---|---|---|---|---|
| | | 90 | 91 | 92 | 93 | 94 |
| Composition (mol %) | Al(PO₃)₃ | 2.13 | 3.30 | 4.55 | 8.07 | |
| | Ba(PO₃)₂ | | | | | 12.11 |
| | Ca(PO₃)₂ | | | | | |
| | Sr(PO₃)₂ | | | | | |
| | AlF₃ | 34.41 | 35.33 | 30.20 | 20.02 | 28.72 |
| | YF₃ | 8.80 | 4.89 | 6.74 | 7.49 | 6.37 |
| | MgF₂ | 7.04 | 6.95 | 4.52 | 4.62 | 4.62 |
| | CaF₂ | 25.07 | 25.90 | 19.80 | 18.46 | 18.96 |
| | SrF₂ | 12.71 | 14.27 | 11.94 | 13.68 | 13.18 |
| | BaF₂ | 9.84 | 9.36 | 19.47 | 21.57 | 9.95 |
| | NaF | | | 2.78 | 6.09 | 6.09 |
| | KF | | | | | |
| | NaCl | | | | | |
| | Total | 100.00 | 100.00 | 100.00 | 100.00 | 100.00 |
| Properties | nd | 1.43542 | 1.4379 | 1.45797 | 1.48311 | 1.48234 |
| | νd | 95.7 | 94.38 | 90.51 | 83.44 | 83.59 |
| | Tg (° C.) | 429 | 436 | 428 | 423 | 424 |
| | Ts (° C.) | 457 | 460 | 457 | 458 | 458 |

TABLE 15

| | | Run No. | | | | |
|---|---|---|---|---|---|---|
| | | 95 | 96 | 97 | 98 | 99 |
| Composition (mol %) | Al(PO₃)₃ | | | | 9.68 | 10.20 |
| | Ba(PO₃)₂ | 6.82 | | | | 2.72 |
| | Ca(PO₃)₂ | | 6.82 | | | |
| | Sr(PO₃)₂ | | | 6.82 | | |
| | AlF₃ | 34.75 | 34.86 | 32.88 | 20.99 | 19.43 |
| | YF₃ | 6.74 | 6.63 | 9.01 | 2.88 | 1.24 |
| | MgF₂ | 4.52 | 4.52 | 4.30 | 5.10 | 5.37 |
| | CaF₂ | 19.80 | 12.98 | 18.66 | 18.79 | 19.54 |
| | SrF₂ | 11.94 | 11.60 | 5.01 | 15.37 | 15.93 |
| | BaF₂ | 12.65 | 19.58 | 20.42 | 19.68 | 17.62 |
| | NaF | 2.78 | 3.01 | 2.90 | 7.51 | 7.95 |
| | KF | | | | | |
| | NaCl | | | | | |
| | Total | 100.00 | 100.00 | 100.00 | 100.00 | 100.00 |
| Properties | nd | 1.45797 | 1.45777 | 1.45762 | 1.48203 | 1.49341 |
| | νd | 90.51 | 90.65 | 90.44 | 82.97 | 80.75 |
| | Tg (° C.) | 428 | 427 | 425 | 420 | 428 |
| | Ts (° C.) | 457 | 457 | 456 | 457 | 464 |

TABLE 16

| | | Run No. | | | | |
|---|---|---|---|---|---|---|
| | | 100 | 101 | 102 | 103 | 104 |
| Composition (mol %) | Al(PO₃)₃ | 12.33 | 9.68 | 11.41 | 13.29 | |
| | Ba(PO₃)₂ | | | | | 20.54 |
| | Ca(PO₃)₂ | | | | | 4.09 |
| | Sr(PO₃)₂ | | | | | |
| | AlF₃ | 15.75 | 22.94 | 17.33 | 13.97 | 24.06 |
| | YF₃ | 2.01 | 0.94 | 2.72 | 1.57 | |
| | MgF₂ | 5.55 | 5.30 | 5.48 | 5.71 | 6.09 |
| | CaF₂ | 19.66 | 19.82 | 20.04 | 19.93 | 17.18 |
| | SrF₂ | 16.70 | 15.16 | 16.24 | 16.92 | 18.06 |
| | BaF₂ | 19.88 | 18.65 | 19.13 | 19.93 | |
| | NaF | 8.12 | 2.74 | 2.95 | 3.78 | 4.76 |
| | KF | | | | | |
| | NaCl | | 4.77 | 4.70 | 4.90 | 5.22 |
| | Total | 100.00 | 100.00 | 100.00 | 100.00 | 100.00 |
| Properties | nd | 1.49705 | 1.48419 | 1.4976 | 1.50572 | 1.51425 |
| | νd | 80.17 | 80.56 | 79.49 | 77.33 | 76.5 |
| | Tg (° C.) | 425 | 408 | 413 | 413 | 413 |
| | Ts (° C.) | 465 | 447 | 450 | 453 | 450 |

(4) Molten glass that were to give glasses shown in Tables 1 to 16 were prepared in a large amount each under the above conditions, and each molten glass was separately caused to flow out from a flow pipe made of a platinum alloy at a constant flow rate.

The molten glasses were caused to flow out in atmosphere, in a dry atmosphere or in an inert gas (nitrogen, argon or a gas mixture of nitrogen with argon) atmosphere containing 0.1 to 50% by volume of oxygen gas.

In each case, a molten glass drop having a predetermined weight was separated from the molten glass flowing out of the pipe by a dropping method, received with a glass gob receiving mold ejecting a gas, and while the glass was caused to float, the glass drop was shaped into a spherical glass gob having a constant weight. In such a manner, molten glass drops dropping at constant intervals were received with the glass gob receiving mold one after another, and while each glass drops were caused to float, they were shaped into glass gobs having a constant weight each one after another. After the glass gobs were cooled to a temperature at which they were not deformed, they were taken out of the mold. In this manner, a plurality of spherical glass gobs were prepared with regard to each of glasses shown in Tables 1 to 16.

Further, a molten glass was separated by a descent-separation method and received with a glass gob mold having a concave portion formed of a porous material, and shaped into a glass gob while a gas was ejected from fine pores of the porous material. In this manner, glass gobs formed of the glass were prepared with regard to each of the glasses shown in Tables 1 to 16. In the above method, while the separation was also carried out at constant time intervals, the above step was repeated to give a plurality of the glass gobs having a constant weight each. The form of each of the thus-shaped glass gobs is a form having one axis of rotation symmetry, having major and minor diameters and having a surface formed of curved surfaces, that is, a form in which the surface is constituted of curved surfaces having different curvatures, and corresponds to a form similar to a planiform sphere.

Each of the thus-prepared glass gobs was cooled to room temperature, then, placed in an annealing furnace and annealed for 1 hour at a temperature 10° C. lower than the glass transition temperature of the corresponding glass, and the gobs were temperature-decreased to room temperature at a rate of 30° C./hour to decrease strains. In addition, all the glass gobs prepared by any method above had high weight accuracy. The thus-obtained glass gobs had a weight tolerance of ±1% or less based on the intended weight.

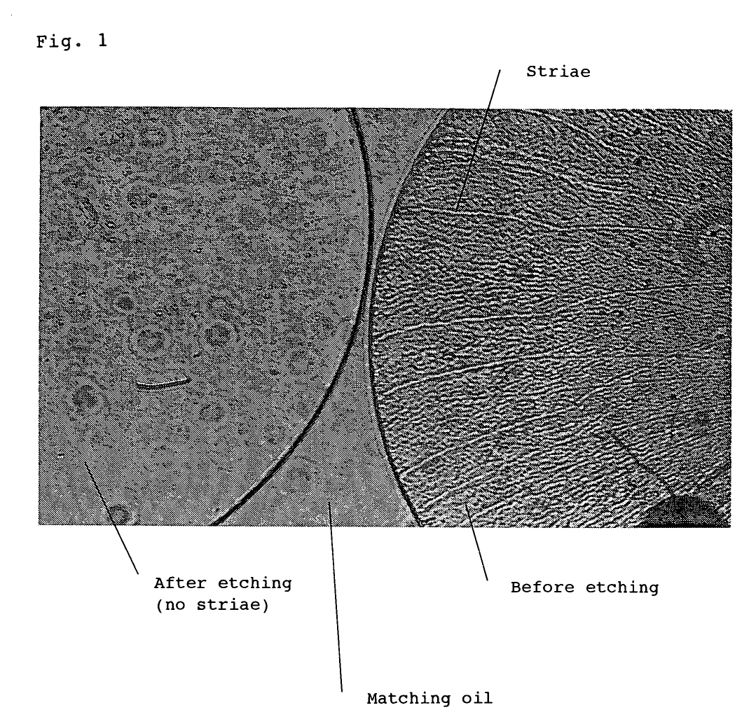

When the surfaces of the above glasses were visually enlarged and observed through an optical microscope, fine surface striae were observed on the entire surface of each glass gobs (see FIG. 1).

(5) Then, there were prepared three etching solutions, i.e., a nitric acid aqueous solution having a nitric acid concentration of 30% by weight, hydrochloric acid having a concentration of 35% by weight and an H₂SiF₆ aqueous solution having an H₂SiF₆ concentration of 2% by weight, and the glass gobs were entirely immersed in each of the etching solutions at room temperature to etch them. All of the surfaces of the glass gobs were etched up to 0.1 mm (100 μm) deep portions to remove surface layers, so that glass gobs having a predetermined weight were obtained. The etched glass gobs were washed, dried and observed through an optical microscope to show no surface striae. Further, the interior of each glass gob was observed to show no internal striae (see FIG. 1). In this manner, there were obtained optically homogeneous glass gobs free of striae, and the glass gobs were used as precision press-molding preforms. In addition, the preforms after the etching had a weight tolerance of +1% or less based on the weight of the intended preform. The above procedures are repeated, to obtain relationships among the kind, concentration and temperature of the etching solution, the immersing time period, the composition of a glass and the depth of etching.

Then, a plurality of glass gobs having the same weights were simultaneously immersed in one of the above etching solutions to remove the entire surface under the conditions that were the same as the above conditions, until the removal reached a 0.1 mm deep portion, to produce preforms having a form similar to that of the glass gobs that were not etched. The thus-produced preforms were optically homogeneous and free of surface striae and internal striae, and no surface devitrification was found. Further, each preform had a predetermined weight and there were simultaneously produced a plurality of preforms having high weight accuracy. Each preform after the etching had a weight tolerance of ±1% based on the weight of the intended preform. For improving the mold releasability in precision press-molding, a mold release film may be formed on the entire surface of each preform. Examples of the mold release film include a carbon film and a self-organizing film.

After the glasses in Runs Nos. 35 to 84 were etched, a gel-like deposit was found on the surface of each glass. For effectively removing such a deposit, before the surface of each preform was dried, the preforms after the etching were entirely and completely immersed in ethanol to bring the entire surface of each into contact with the ethanol, and then washed with water to remove the gel-like deposit. The above deposit can be also removed when isopropyl alcohol is used in place of the above ethanol. After a plurality of glass gobs are etched, they are together immersed in ethanol or isopropyl alcohol, whereby the entire surface of each of the plurality of preforms can be brought into an organic solvent. When the preforms are thereafter washed together, there can be effectively obtained preforms having a clean surface each.

Instead of bringing the glass surface into contact with the above organic solvent, there may be employed a constitution in which a mixture of hydrochloric acid with ethanol or a mixture of hydrochloric acid with isopropyl alcohol is prepared, glass gobs were etched with the mixture as an etching solution, and the glass gobs are washed with ethanol or isopropyl alcohol, whereby preforms free of any gel-like deposit can be produced. In the above manner, preforms having a clean surface can be effectively obtained.

Instead of the above method using the organic solvent or the above method using a mixture of hydrochloric acid with an alcohol, further, there may be also employed a constitution in which the preforms after the etching are scrubbed before the surfaces of the preforms are dried, to remove the gel-like deposit.

Then, with regard to each of glasses having the same compositions as those described above, glass pieces were cut from a plate-shaped glass, and the glass pieces were ground and polished to produce glass gobs. When the glass gobs were etched according to the above various etching methods, there were produced preforms excellent in surface quality and internal quality. In this case, a gel-like deposit formed by the etching can be removed, or the formation of the above deposit can be decreased or prevented, by the above various methods.

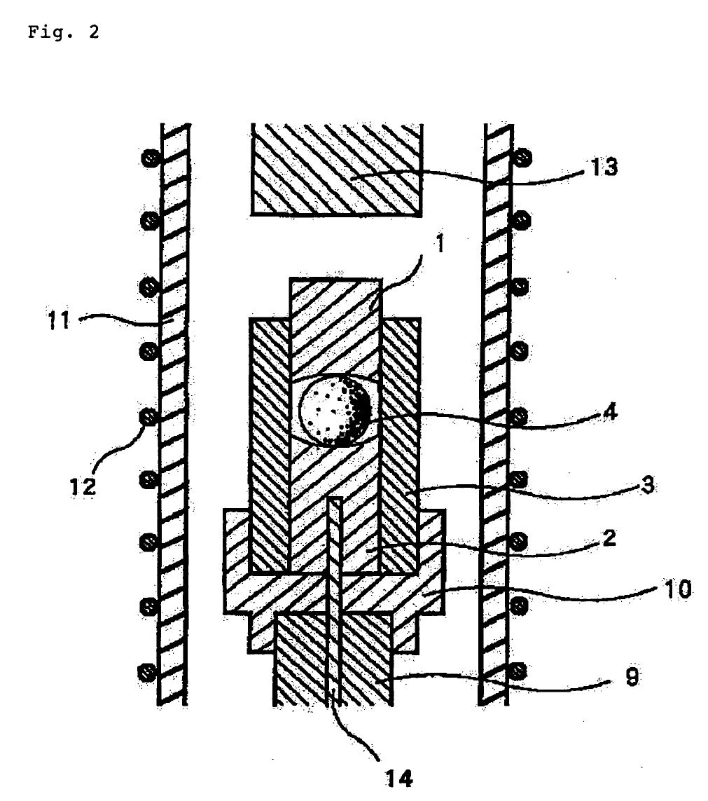

(6) The thus-obtained preforms were heated and precision press-molded (aspherically precision-pressed) with a pressing apparatus shown in FIG. 2 to give aspherical lenses. The precision press-molding is detailed below. A preform 4 was placed between a lower mold member 2 and an upper mold member 1 each of which had an aspherical form and which were made of SiC, and then a nitrogen atmosphere was employed as an atmosphere in a quartz tube 11. A heater 12 was electrically powered to heat an inside of the quartz tube 11. The temperature inside a press mold was set at a temperature that was +20 to 60° C. higher than the sag temperature of a corresponding glass, and while this temperature was maintained, a pressing rod 13 was moved downward to press the upper mold member 1, whereby the preform 4 in the press mold was precision press-molded. The pressing was carried out at a pressure of 8 MPa for a molding time period of 30 seconds, and after the pressing, the molding pressure was decreased. While the thus-molded aspherical lens formed of the optical glass was in contact with the lower mold member 2 and the upper mold member 1, the spherical lens was gradually cooled to a temperature that was 30° C. lower than the glass transition temperature of the corresponding glass, and then rapidly cooled to room temperature. Then, the aspherical lens was taken out of the press mold, measured for a form and inspected with regard to its appearance. Aspherical lenses obtained in the above manner had remarkably high accuracy. In addition, numeral 3 indicates a sleeve mold member, numeral 9 indicates a support rod, numeral 10 indicates a support base, and numeral 14 indicates a thermocouple.

When the above lenses were visually enlarged and observed through an optical microscope, neither surface striae nor internal striae were observed like the preforms used, and it was found that they were high-quality lenses.

A high quality and highly accurate spherical lens formed of an optical glass can be also formed by a method in which the above preform preheated is introduced to a press mold and precision press-molded.

In addition, the form and dimensions of the preform can be determined as required depending upon the form, etc., of a precision press-molded product to be produced.

In the above Examples, aspherical lenses were produced. However, when press molds in conformity with end products are used, various aspherical or spherical lenses such as a convex meniscus lens, a concave meniscus lens, a plane-convex lens, a double convex lens, a plane-concave lens, a double convex lens, etc., or optical elements such as a prism, a polygon mirror, a diffracting grating, etc., can be produced.

An optical multi-layered film such as an anti-reflection film, a high reflection film, or the like may be formed on the optical-function surface of each of the thus-obtained optical elements as required.

Industrial Utility

According to the process for producing a precision press-molding preform, provided by the present invention, high-quality precision press-molding preforms can be highly productively produced by the hot shaping of a glass. Further, by precision press-molding of preforms shaped by the above process, high-quality optical elements can be highly productively produced.

1. A process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said surface layer has a thickness of 0.5 μm or more.

2. A process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said optical glass has a viscosity of 10 dPa·s or less at a liquidus temperature of the glass.

3. A process for producing a precision press-molding preform having a predetermined weight from a molten glass, wherein the molten glass is shaped into a glass gob and said glass gob is etched to remove a surface layer of the glass gob to produce the precision press-molding preform formed of an optical glass having said weight, and further wherein said optical glass is an optical glass having a refractive index (nd) of at least 1.65 and an Abbe's number (vd) of 58 or less.

4. A process for producing a precision press-molding preform having a predetermined weight from a molten glass,
which comprises shaping the molten glass into a glass gob, annealing the glass gob and etching said glass gob to remove a surface layer of the glass gob, and thereby producing the precision press-molding preform formed of an optical glass having said weight.

5. A process for producing a precision press-molding preform having a predetermined weight from a molten glass,
which comprises repeating the step of shaping the molten glass into a glass gob to prepare a plurality of glass gobs having the predetermined weight each, etching said plurality of glass gobs under constant conditions to remove a surface layer of each glass gob, and thereby producing a plurality of precision press-molding preforms each of which is formed of an optical glass having said weight.

6. The process for producing a precision press-molding preform as recited in any one of claims 1 to 5, wherein the entire glass gob is immersed in an etching solution to etch the glass gob.

7. The process for producing a precision press-molding preform as recited in any one of claims 1 to 5, wherein the molten glass is shaped into a glass gob having a surface constituted of curved surfaces having different curvatures or a spherical glass gob.

8. A process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.65 or more and an Abbe's number (vd) of 35 or less and containing P₂O₅, Nb₂O₅ and Li₂O.

9. A process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass comprising, by mol %, 15 to 45% of P₂O₅, 3 to 35% of Nb₂O₅, 2 to 35% of Li₂O, 0 to 20% of TiO₂, 0 to 40% of WO₃, 0 to 20% of Bi₂O₃, 0 to 30% of B₂O₃, 0 to 25% of BaO, 0 to 25% of ZnO, 0 to 20% of MgO, 0 to 20% of CaO, 0 to 20% of BrO, 0 to 30% of Na₂O, 0 to 30% of K₂O, provided that the total content of Li₂O, Na₂O and K₂O is 45% or less, 0 to 15% of Al₂O₃, 0 to 15% of SiO₂, 0 to 10% of La₂O₃, 0 to 10% of Gd₂O₃, 0 to 10% of Yb₂O₃, 0 to 10% of ZrO₂ and 0 to 10% of Ta₂O₅.

10. The process for producing a precision press-molding preform as recited in claim 8 or 9, wherein the glass gob is formed of a glass having a viscosity of 10 dPa·s or less at a liquidus temperature of the glass.

11. The process for producing a precision press-molding preform as recited in claim 8 or 9, wherein the glass gob is immersed in an etching solution to etch the glass gob.

12. The process for producing a precision press-molding preform as recited in claim 8 or 9, wherein the entire surface of the glass gob is etched to remove a surface layer having a depth of at least 0.5 μm, to produce the precision press-molding preform having a predetermined weight.

13. The process for producing a precision press-molding preform as recited in claim 8 or 9, wherein the glass gob is annealed and then etched.

14. A process for producing a precision press-molding preform from a molten glass, wherein the molten glass is shaped into a glass gob and the entire surface of said glass gob is etched to produce a precision press-molding preform formed of an optical glass having a predetermined weight, and further wherein said optical glass is an optical glass having a refractive index (nd) of 1.75 or more and an Abbe's number (vd) of 25 to 58 and containing B₂O₃ and La₂O₃.

15. A process for producing a precision press-molding preform from a molten glass, wherein the molten glass is shaped into a glass gob and the entire surface of said glass gob is etched to produce a precision press-molding formed of an optical glass having a predetermined weight, and further wherein said optical glass is an optical glass containing, by mol %, 15 to 60% of B₂O₃, 0 to 40% of SiO₂, 5 to 22% of La₂O₃, 0 to 20% of Gd₂O₃, 0 to 45% of ZnO, 0 to 15% of Li₂O, 0 to 10% of Na₂O, 0 to 10% of K₂O, 0 to 15% of ZrO₂, 0 to 15% of Ta₂O₅, 0 to 15 % of WO₃, 0 to 10% of Nb₂O₅, 0 to 15% of MgO, 0 to 15% of CaO, 0 to 15% of SrO, 0 to 15% of BaO, 0 to 15% of Y₂O₃, 0 to 15% of Yb₂O₃, 0 to 20% of TiO₂, 0 to 10% of Bi₂O₃ and 0 to 1% of Sb₂O₃.

16. The process for producing a precision press-molding preform as recited in claim 14 or 15, wherein the glass gob has a viscosity of 10 dPa·s or less at a liquidus temperature thereof.

17. The process for producing a precision press-molding preform as recited in claim 14 or 15, wherein the glass gob is immersed in an etching solution to etch the glass gob.

18. The process for producing a precision press-molding preform as recited in claim 14 or 15, wherein the entire surface of the glass gob is etched to remove a surface layer having a depth of at least 0.5 μm, to produce a precision press-molding preform having a predetermined weight.

19. The process for producing a precision press-molding preform as recited in claim 14 or 15, wherein the glass gob is annealed and then etched.

20. A process for producing a precision press-molding preform formed of an optical glass containing B₂O₃,
which comprises the step of etching the surface of a glass gob formed of said optical glass with an etching solution and then bringing said surface into contact with an organic solvent or the step of etching said glass gob with an etching solution that is a mixture of an acid or an alkali with an alcohol.

21. A process for producing a precision press-molding preform formed of an optical glass containing B₂O₃,
which comprises the step of etching the surface of a glass gob formed of said optical glass with an etching solution and the step of washing the etched glass gob by scrubbing.

22. A process for producing a precision press-molding preform from a molten glass,
which comprises shaping the molten glass that is a fluorine-containing glass into a glass gob, etching said glass gob to remove a surface layer of the glass gob, and thereby producing the precision press-molding preform.

23. The process for producing a precision press-molding preform as recited in claim 22, wherein the glass is a fluorophosphate glass.

24. The process for producing a precision press-molding preform as recited claim 23, wherein the fluorophosphate glass contains, by mol %, 0 to 20% of Al(PO₃)₃, 0 to 30 % of Ba(PO₃)₂, 0 to 30% of Mg(PO₃)₂, 0 to 30% of Ca(PO₃)₂, 0 to 30% of Sr(PO₃)₂, 0 to 30% of Zn(PO₃)₂, 0 to 15% of NaPO₃, 2 to 45% of AIF₃, 0 to 10% of ZrF₄, 0 to 15% of YF₃, 0 to 15% of YbF₃, 0 to 15% of GdF₃, 0 to 15% of BiF₃, 0 to 10% of LaF₃, 0 to 20% of MgF₂, 2 to 45% of CaF₂, 2 to 45% of SrF₂, 0 to 20% of ZnF₂, 0 to 30% of BaF₂, 0 to 10% of LiF, 0 to 15% of NaF, 0 to 15% of KF, 0 to 5% of Li₂O, 0 to 5% of Na₂O, 0 to 5% of K₂O, 0 to 5% of MgO, 0 to 5% of CaO, 0 to 5% of SrO, 0 to 5% of BaO and 0 to 5% of ZnO.

25. The process for producing a precision press-molding preform as recited in claim 22, wherein the glass has an abrasion degree F_{A} of 150 or more.

26. The process for producing a precision press-molding preform as recited in claim 22, wherein the glass gob is etched until the surface layer having a depth of 0.5 μm or more from the surface is removed, to produce the preform having a predetermined weight.

27. The process for producing a precision press-molding preform as recited in claim 22, wherein the molten glass is shaped into a glass gob having a surface constituted of curved surfaces having different curvatures or a spherical glass gob.

28. The process for producing a precision press-molding preform as recited in claim 22, wherein the glass gob is immersed in an etching solution to etch the glass gob.

29. The process for producing a precision press-molding preform as recited in claim 22, wherein the step of shaping a glass gob from a molten glass was repeated to produce a plurality of glass gobs having a constant weight each and said plurality of glass gobs were etched under constant conditions to produce a plurality of preforms having a predetermined weight each.

30. The process for producing a precision press-molding preform as recited in claim 22, wherein the glass gob is annealed and then etched.

31. A process for producing an optical element, which comprises the step of precision press-molding the precision press-molding preform produced by the process recited in any one of claims 1 to 5, 8, 9, 14, 15, 20, 21 or 22.

32. The process for producing an optical element as recited in claim 31, wherein the preform is introduced into a press mold, and said press mold and the preform are heated together to carry out the precision press-molding.

33. The process for producing an optical element as recited in claim 31, wherein the preform is preheated and then introduced into the press mold to carry out the precision press-molding.
